(19) United States
(12) Patent Application Publication
(10) Pub. No.: US 2025/0053293 A1
(43) Pub. Date: Feb. 13, 2025

(54) METHOD AND SYSTEM OF A USER INTERFACE OF AN ENTITY MAPPER

(71) Applicants: Tanuj Shah, Bengaluru (IN); anuj shah, Bengaluru (IN)

(72) Inventors: Tanuj Shah, Bengaluru (IN); anuj shah, Bengaluru (IN)

(21) Appl. No.: 18/784,898

(22) Filed: Jul. 25, 2024

Related U.S. Application Data
(60) Provisional application No. 63/528,649, filed on Jul. 25, 2023.

(51) Int. Cl. G06F 3/0486; G06F 3/04817; G06F 3/0485

(52) U.S. Cl. CPC G06F 3/0486; G06F 3/04817; G06F 3/0485

(57) ABSTRACT

In one aspect, a computerized method for implementing the behavior of an entity mapper comprising: creating an entity mapper comprising a plurality of entities, wherein each entity of the plurality of entities; configuring each entity of the plurality of entities to be rearranged by a horizontal dragging operation and a scrolling operation; and configuring each entity of the plurality of entities as a digital display image comprising an entity icon.

### CLAIM OF PRIORITY

This application claims priority to U.S. Provisional Patent Application No. 63/528,649, filed on Jul. 25, 2023 and titled METHOD AND SYSTEM OF A USER INTERFACE OF A PERSONA MAPPER. This provisional patent application is hereby incorporated by reference in its entirety.

### BACKGROUND

This application related to human-computer interfaces and more specifically to a user interface of an entity mapper. There is a desire for improvements to understanding how entities in data sets relate to each other. Accordingly, the present invention provides improvements to showing relationships between entities in a database while also showing attributes of the entities themselves.

### SUMMARY OF THE INVENTION

In one aspect, a computerized method for implementing the behavior of an entity mapper comprising: creating an entity mapper comprising a plurality of entities, wherein each entity of the plurality of entities; configuring each entity of the plurality of entities to be rearranged by a horizontal dragging operation and a scrolling operation; and configuring each entity of the plurality of entities as a digital display image comprising an entity icon.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for implementing the behavior of an entity mapper, according to some embodiments.

FIG. 2 illustrates an example process for implementing entities and attributes, according to some embodiments.

FIG. 3 illustrates an example process for setting a Scale Value, according to some embodiments.

FIG. 4 illustrates an example screenshot showing Hotspot dialog box operations, according to some embodiments.

FIGS. 5-6 illustrate example screenshots showing inter-hotspot distance is directly proportional to the number of scale values, according to some embodiments.

FIGS. 7-8-9 illustrate example entity icons and entity marker icons, according to some embodiments.

FIG. 10 illustrates an example of attribute scale Hotspot screenshot, according to some embodiments.

FIG. 11 illustrates an example screenshot of different entity marker icons, according to some embodiments.

FIG. 12 illustrates an example screenshot of line segment operations, according to some embodiments.

FIG. 13 illustrates an example screenshot of entity mapping, according to some embodiments.

FIG. 14 illustrates an example screenshot of Attribute Position Change/Rearrange, according to some embodiments.

FIG. 15 illustrates an example screenshot of Section Position Change/Rearrange, according to some embodiments.

FIG. 16 illustrates an example screenshot of Entity Position Change/Rearrange, according to some embodiments.

FIG. 17 illustrates an example Visual Representation for Entities screenshot, according to some embodiments.

FIG. 18 illustrates an example screenshot showing horizontal scrolling of the entity section, according to some embodiments.

FIG. 19 illustrates an example screenshot showing Attribute Analysis according to some embodiments.

FIG. 20 illustrates an example Similarity Analysis screenshot, according to some embodiments.

FIG. 21 illustrates an example Entity Score Analysis screenshot, according to some embodiments.

FIG. 22 illustrates an example screenshot of a template that provides a starting point for the user to begin creating their Mapper, according to some embodiments.

FIG. 23 illustrates an example screenshot of an Entity Mapper report, according to some embodiments.

FIG. 24 illustrates an example screenshot of an Entity Mapper, according to some embodiments.

FIG. 25 illustrates an example screenshot of the Attributes Library provided by the mapper tool, according to some embodiments.

FIG. 26 illustrates an example screenshot for accessing additional information for an entity, according to some embodiments.

FIGS. 27-28 illustrate screenshots showing editing operations, according to some embodiments.

FIG. 29 illustrates an example screenshot of entity image selection and management, according to some embodiments.

FIG. 30 depicts an exemplary computing system that can be configured to perform any one of the processes provided herein, according to some embodiments.

FIG. 31 illustrates an example screenshot of the use of AI in the Entity Mapper to generate Attributes, according to some embodiments.

FIG. 32 illustrates an example screenshot of the use of AI to generate an Entity Mapper, according to some embodiments.

FIG. 33 illustrates an example screenshot of the Commenting Functionality, according to some embodiments.

FIG. 34 illustrates an example screenshot of the available Personalization and Customization of entity line patterns, entity line colors, entity marker icons, mapper background watermarks, etc., according to some embodiments.

FIG. 35 illustrates an example screenshot of how the entity mapper looks in the mobile view, according to some embodiments.

FIG. 36 illustrates an example screenshot of how the mapper can be used to map, compare or analyze any type and number of entities, with attributes that could be mapped on a scale for each entity, according to some embodiments.

FIG. 37 illustrates an example screenshot of a sticky note that can be positioned anywhere on the entity mapper according to some embodiments.

FIG. 38 illustrates an example screenshot of the details section of the entity mapper popping out to emphasize attributes, according to some embodiments.

FIG. 39 illustrates an example screenshot of the use of AI to chat with an Entity Mapper, according to some embodiments.

FIG. 40 illustrates an example screenshot of a separate view of a single entity in the entity mapper report along with a highlighted view of the demographics or details section, according to some embodiments.

FIG. 41 illustrates an example screenshot of the different toolbars available on the entity mapper, according to some embodiments.

FIG. 42 illustrates an example screenshot highlighting with a line an entity of type company, according to some embodiments.

FIG. 43 illustrates an example screenshot of Gap Analysis of multiple entities compared to another entity within the entity mapper, according to some embodiments.

FIG. 44 illustrates an example screenshot of the use of a dropdown menu to select an entity for conducting Gap Analysis, according to some embodiments.

The Figures described above are a representative set and are not exhaustive with respect to embodying the invention.

### DESCRIPTION

Disclosed are a system, method, and article of manufacture for a user interface of an Entity Mapper. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

The following terminology is used in example embodiments:

An Entity Mapper can be a versatile digital collaborative tool designed to facilitate the mapping, comparing, evaluating, and assessing of various entities based on their distinct characteristics and/or attributes. Entity is an item that is being mapped, evaluated or assessed using the Mapper tool. Entity can be a persona, a user persona, a person, a fictional person, a product, a company, a service, or any other entity that has details relevant to the type of entity (for e.g. Name, Age, Gender, etc), or (for e.g. Revenue, Company Size, etc.), and Attributes relevant to the type of entity (for e.g Tasks, Needs, Goals, Behaviors, etc.), (or for e.g. Vision, Goals, Product Features, Values of a company, etc.), where the Attributes of an entity can be mapped to a specific Scale Value. The Entity attributes are mapped on an V point discrete or continuous scale, where V represents the number of points on a scale, and each attribute can be mapped to a specific value on the scale. Note, the Persona Mapper definitions in Provisional Patent Application No. 63/528,649 have been extended to the Entity Mapper.

Generative artificial intelligence (AI) systems/models can generate, inter alia: text, images, or other media in response to prompts. Generative AI models learn the patterns and structure of their input training data, and then generate new data that has similar characteristics.

Generative pre-trained transformers (GPT) are a type of LLM that can be utilized as a framework for generative artificial intelligence.

Large language model (LLM) is a computerized language model consisting of an artificial neural network with many parameters (e.g. tens of millions to billions), trained on large quantities of unlabeled text using self-supervised learning or semi-supervised learning.

Learning management system (LMS) is a software application for the administration, documentation, tracking, reporting, automation, and delivery of educational courses, training programs, materials or learning and development programs.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Natural language processing (NLP) is an interdisciplinary subfield of linguistics, computer science, and artificial intelligence concerned with the interactions between computers and human language, in particular how to program computers to process and analyze large amounts of natural language data.

Entity Mapper is a tool for mapping attributes (e.g. needs, goals, etc.) of multiple entities on a V point discrete (e.g. five-point scale) or continuous scale (e.g. a temperature scale), where V represents the number of points on a scale.

Entity is an item that is being mapped, evaluated or assessed using the Mapper tool. Entity can be a persona, a user persona, a person, a fictional person, a product, a company, a service, or any other entity that has characteristic details relevant to the type of entity (for e.g. Name, Age, Gender, etc), or (for e.g. Revenue, Company Size, etc.), and Attributes relevant to the type of entity (for e.g Tasks, Needs, Goals, Behaviors, etc.), (or for e.g. Vision, Goals, Product Features, Values of a company, etc.), where the Attributes of an entity can be mapped to a specific Scale Value.

An attribute is a quality or characteristic that can be associated with different entities. Attributes can be grouped together in sections. An attribute can be one-sided (e.g. “Increase Earning” is a one-sided attribute that can have low or high importance for an entity, etc.). An attribute can also be two sided (e.g. Behavior is a two-sided attribute that can be either “Indecisive” or “Decisive”, etc.).

A Scale Value is a discrete or continuous set of values that can be used to represent the importance of an attribute for each entity

Attribute Scale Value represents the connection for an Entity with an Attribute at position m and a Scale Value at position v.

An Entity Icon serves as a visual identifier for selecting and associating the Entity with an Attribute Scale Value.

An Entity Marker icon is a symbol that denotes a single entity and is present at the beginning of each entity connection line and at each attribute scale value.

A hotspot is graphical marker, for e.g. a “+” icon or point of interaction that represents specific Scale Values on an Attribute Scale

These definitions are provided by way of example and not of limitation. They can be integrated into various example embodiments discussed infra.

### Example Systems and Methods

### Entities and Mappers

The concepts of entities and mappers are now discussed. Entity can be a persona, a user persona, a person, a fictional person, a product, a company, a service, or any other entity that has details relevant to the type of entity (for e.g. Name, Age, Gender, etc), or (for e.g. Revenue, Company Size, etc.), and Attributes relevant to the type of entity (for e.g Tasks, Needs, Goals, Behaviors, etc.), (or for e.g. Vision, Goals, Product Features, Values of a company, etc.), where the Attributes of an entity can be mapped to a specific Scale Value.

The Attribute Scale Value for each entity is mapped using a specific-colored line that belongs to that entity and helps tracking the information till the end attribute-by-attribute. Attribute Scale Value can be selected for each attribute and can be changed after selecting that entity and changing the points joining the line either by selection or dragging or simply selecting another point on that scale row.

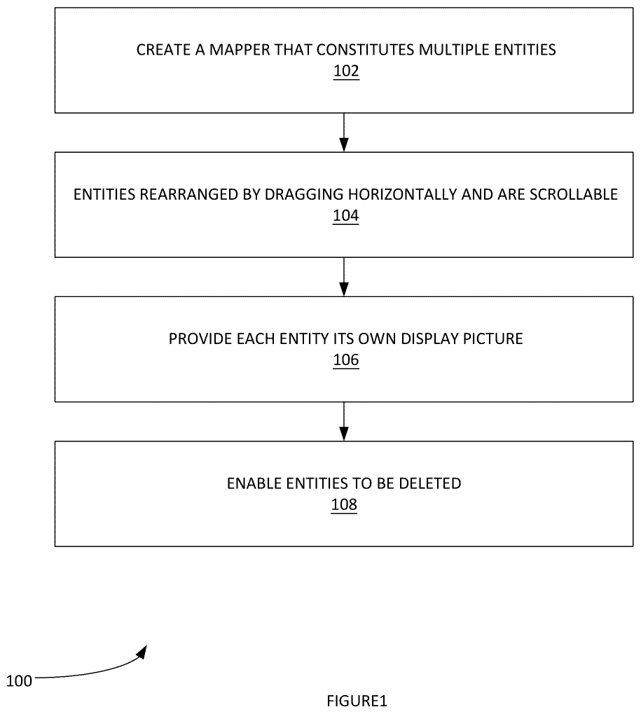

FIG. 1 illustrates an example process 100 for implementing the behavior of an entity mapper, according to some embodiments. In step 102, process 100 provides that mapper constitutes multiple entities. The maximum number of entities that can be added are not limited. Entities can be rearranged by dragging horizontally and are scrollable in step 104. Process 100 provides each entity its own display picture known as entity icon in step 106. The entity can be deleted in step 108. Deleting entity can delete all its subsequent information section/attribute wise.

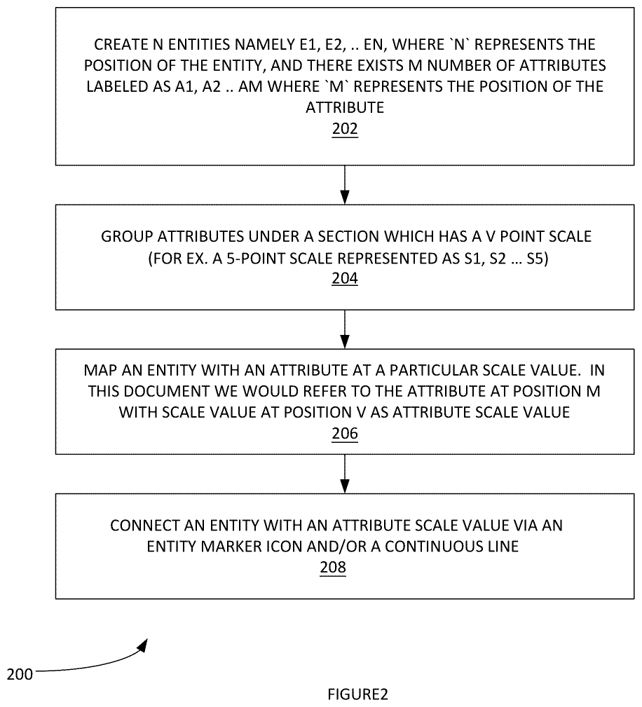

FIG. 2 illustrates an example process 200 for implementing entities and attributes, according to some embodiments. In step 202, process 200 can provide for N entities namely E1, E2, . . . . En, where ‘n’ represents the position of the entity, and there exists M number of attributes labeled as A1, A2 . . . . Am where ‘m’ represents the position of the attribute. In step 204, process 200 can group attributes under a Section which has V points on a scale labeled as S1, S2 . . . . Sv, where ‘v’ represents the point on the scale. The scale in a section remains the same for all the attributes in that section.

In step 206, the tool (e.g. entity mapper, mapper tool, etc.) is used to map an entity with an attribute at a particular scale value. As used herein, we would refer to the Attribute at position m with Scale Value at position v as Attribute Scale Value. In step 208, the tool can connect an entity with an Attribute Scale Value via a line. Every entity is represented by a unique color and marker icon. The color of the entity is the same as the connecting line for the entity. The assigned marker icon of the entity remains the same for all of its connections with its attribute scale values. The marker icon helps distinguish connections of different entities on the entity mapper. The assigned color and the assigned marker icon of any entity can be changed for accessibility and/or better visibility.

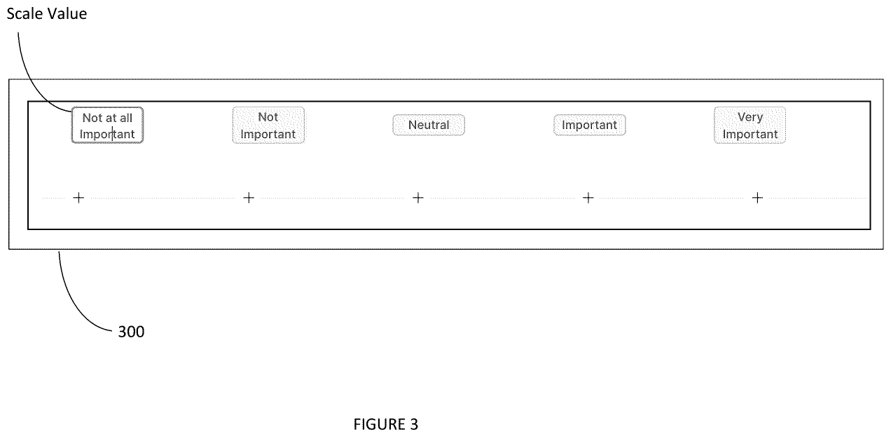

FIG. 3 illustrates an example process 300 for setting a Scale Value, according to some embodiments. As shown, the Attribute Scale Values for an attribute are represented by Hotspots which can be depicted by a + icon.

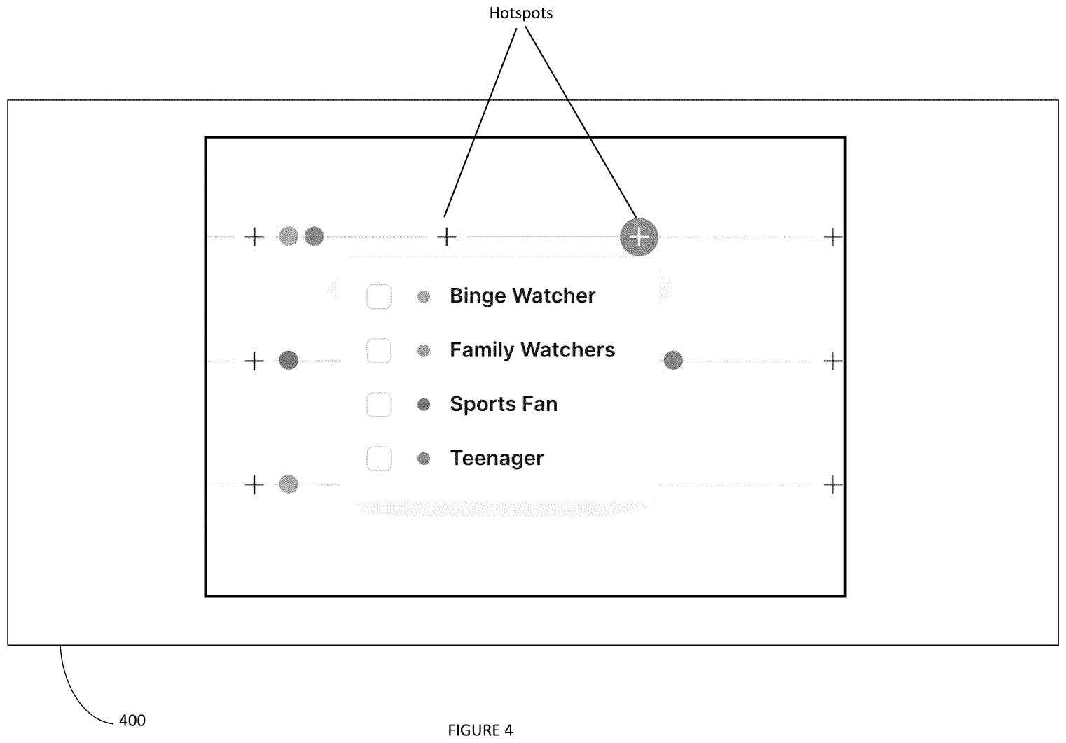

FIG. 4 illustrates an example screenshot 400 showing Hotspot dialog box operations, according to some embodiments. Clicking on the hotspot opens a dialog box that lists all Entities (E1, E2, . . . , En) with corresponding checkboxes as shown in FIG. 4, according to some embodiments. Connections between one Scale Value and multiple Entities can be made by selecting multiple checkboxes in the dialog box.

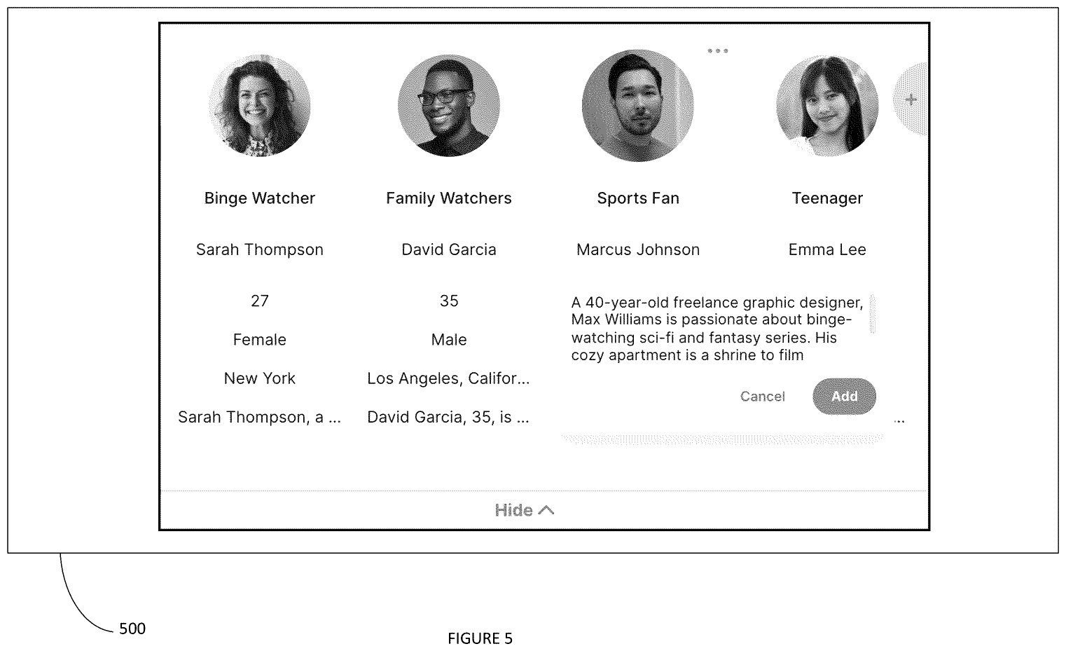

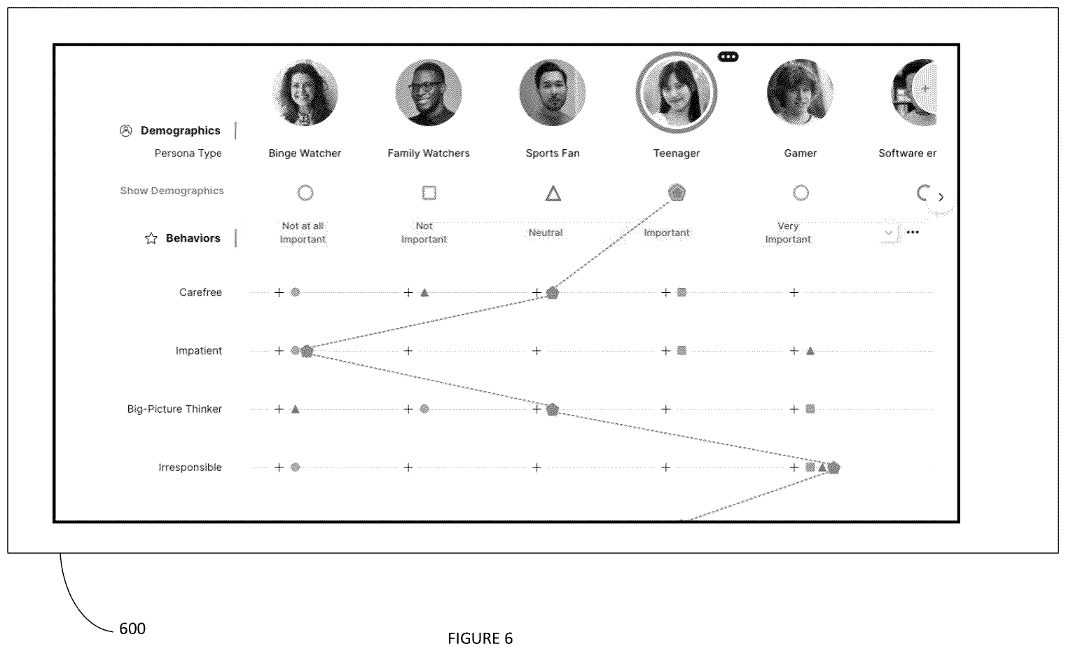

FIGS. 5-6 illustrate example screenshots 500-600 showing inter-hotspot distance is directly proportional to the number of entities, according to some embodiments. In this way, as the number of entities increases, the distance between any two hotspots or scale values also increases. Conversely, as the number of entities decreases, the distance between any two hotspots or scale values also decreases and gets fixed at a certain point.

Connecting an Entity with Attributes is now discussed. Connecting an Entity with Attributes can refer to establishing a link or association between a specific entity and an Attribute Scale Value.

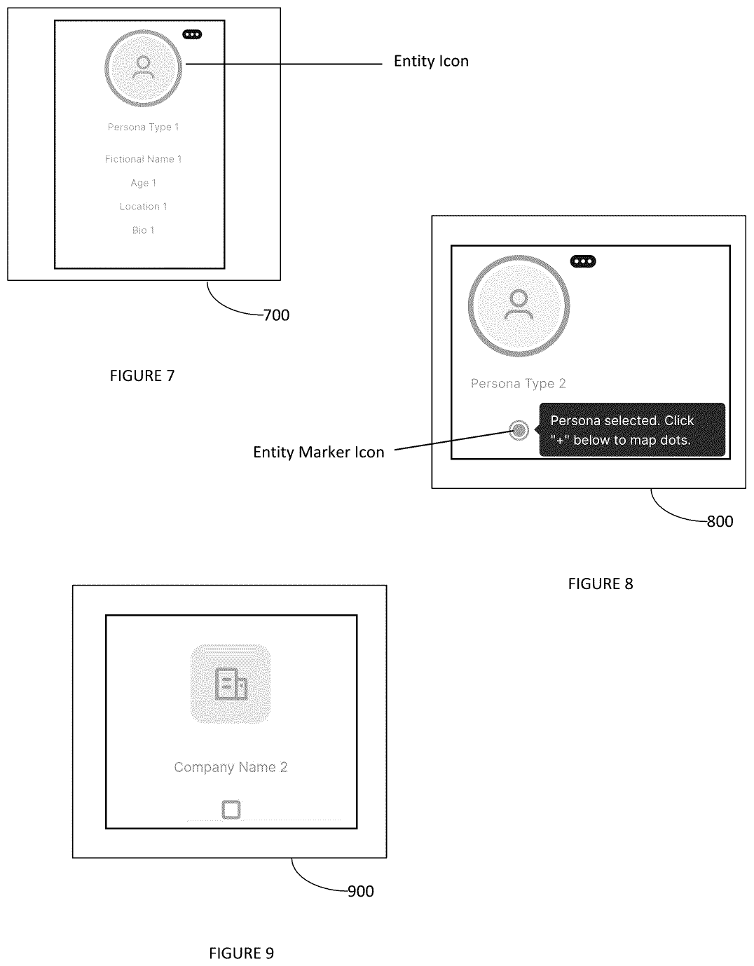

FIGS. 7-8-9 illustrate example screenshots 700-800-900 of entity icons, according to some embodiments. An entity icon can be the icon that serves as a visual identifier for selecting and associating the Entity with an Attribute Scale Value. Clicking this icon activates the line drawing mechanism. An Entity icon is represented by an image or picture representing the entity provided by the user or by a placeholder icon provided by the tool. An Entity Marker icon is represented by a symbol at the beginning of each entity line connecting to the attribute scale values. An Entity Marker Icon can be an interaction point that can also be used to establish a connection. Clicking this icon also activates the line drawing or connection mechanism.

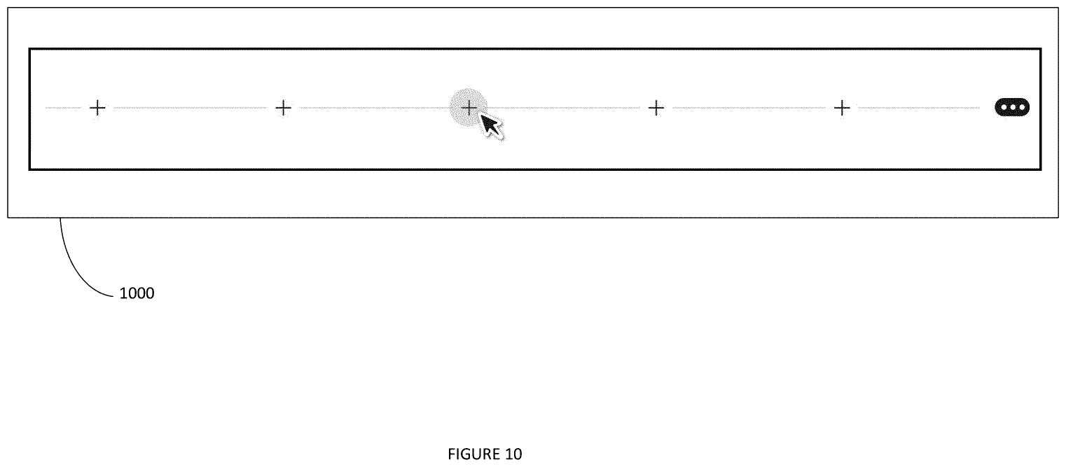

FIG. 10 illustrates an example hotspot screenshot 1000, according to some embodiments. A hotspot can be a graphical marker, for e.g. a “+” icon or point of interaction that represents specific Scale Values on an Attribute Scale. By clicking on a hotspot, the user indicates their selection of a particular attribute scale value associated with entities. Clicking on a hotspot connects the activated entity with the chosen Attribute Scale Value, indicating that the entity possesses the associated attribute scale value.

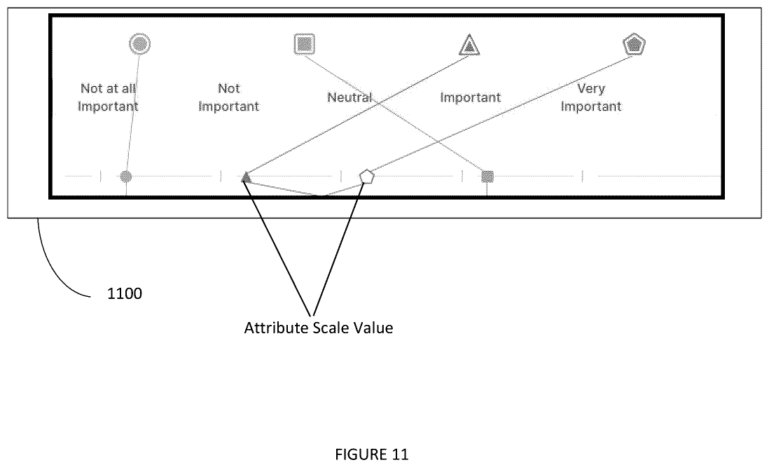

FIG. 11 illustrates an entity marker icon screenshot 1100, according to some embodiments. The marker icon (e.g. a circle, heart, square, rhombus, triangle, or any shape) adopts the color of the corresponding entity. It is noted that when establishing a new connection between an Entity and an Attribute Scale Value, a line segment is generated. Once the line segment is established, the marker icon appears, or undergoes an animation or movement, causing it to shift towards the right side of the hotspot. This line serves the purpose of visually indicating the connection between the entity and the hotspot. Clicking any marker icon also activates the entity and connection line associated with it. The color of this line segment matches that of the entity.

It is noted that if the selected attribute is located at position 1, a line segment is created between the marker icon associated with the entity and the selected hotspot. It is noted that if the selected attribute is not at position 1 and there are no existing connections for the selected entity with any hotspot above this attribute, a line segment is formed directly between the marker icon associated with the entity and the hotspot in the chosen attribute at position M. It is noted that if the selected attribute is not at position one (1) and there is a previous connection for the selected entity with an attribute scale value, a line segment is established between the marker icon associated with that entity in the last hotspot and the currently selected hotspot.

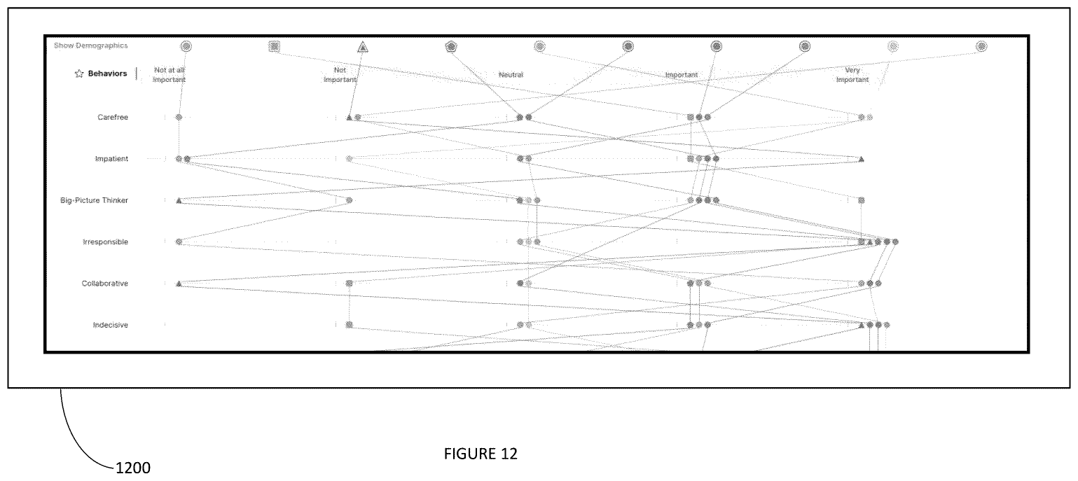

FIG. 12 illustrates example line segment operations screenshot 1200, according to some embodiments. The line segment representing a connection between an entity and an Attribute Scale Value can be a straight line or a line that can be divided into three distinct parts. The first part is a shorter line segment that originates from the starting point and intersects the longer line segment at an angle. The second part is another shorter line segment that starts at an angle from the longer line segment and extends to the endpoint of the connection. The final part is the line segment that connects the two shorter line segments, completing the visual representation of the connection.

When establishing a new connection between an Entity and an Attribute Scale Value, if there are existing connections between the same Scale Value and other Entities, a sorting and repositioning process of the entity marker icons is initiated. The Marker Icons, representing the existing connections, are reordered based on the position or order of the Entities in the top and subsequently appear in the correct order on the side of the hotspot. This sorting ensures that the Marker Icons on each hotspot on the scale aligns with the order of the appropriate Entities, creating a visually coherent representation of the connections within the interface or system.

All the Marker Icons between multiple attribute scale values for each entity are connected, thereby making a line for a single entity. Upon activation of the entity icon/entity marker icon through user interaction, a highlighting effect is applied to the connecting line associated with the respective entity. Also, the entity icon is highlighted by a border that has the same color as that of the entity line. This highlighting serves the purpose of visually distinguishing the line associated with the clicked entity from other connecting lines pertaining to different entities.

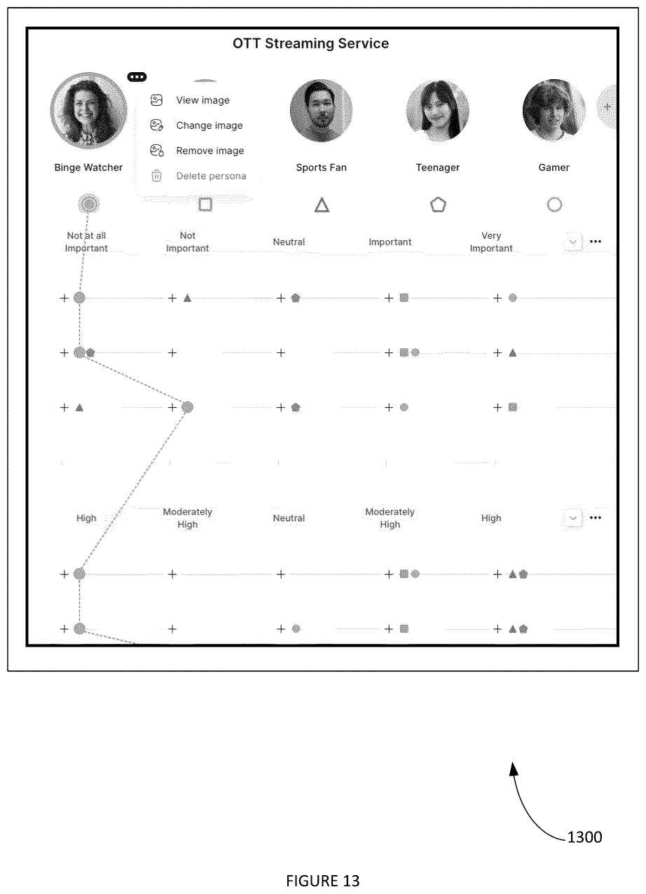

FIG. 13 illustrates an example of entity mapping screenshot 1300, according to some embodiments.

Re-Arrangement Logic is now discussed.

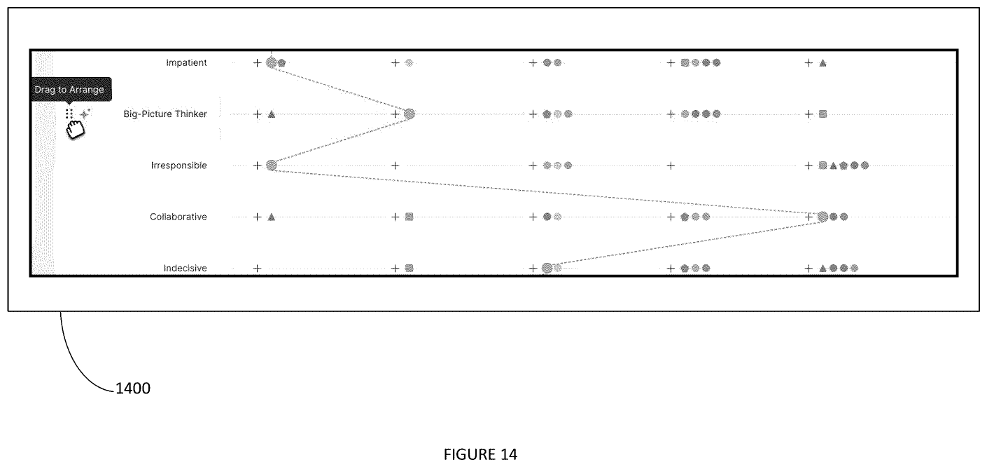

FIG. 14 illustrates an example attribute Position Change screenshot 1400, according to some embodiments. The position of an attribute within a section can be modified by employing a drag-and-drop action or clicking the move up or down interaction from the attribute menu, where the attribute is moved to a new location within the section. As a result of this action, the line segments connecting the attribute scale values of this attribute to the entity marker icons for all associated entities are automatically updated to reflect the new position.

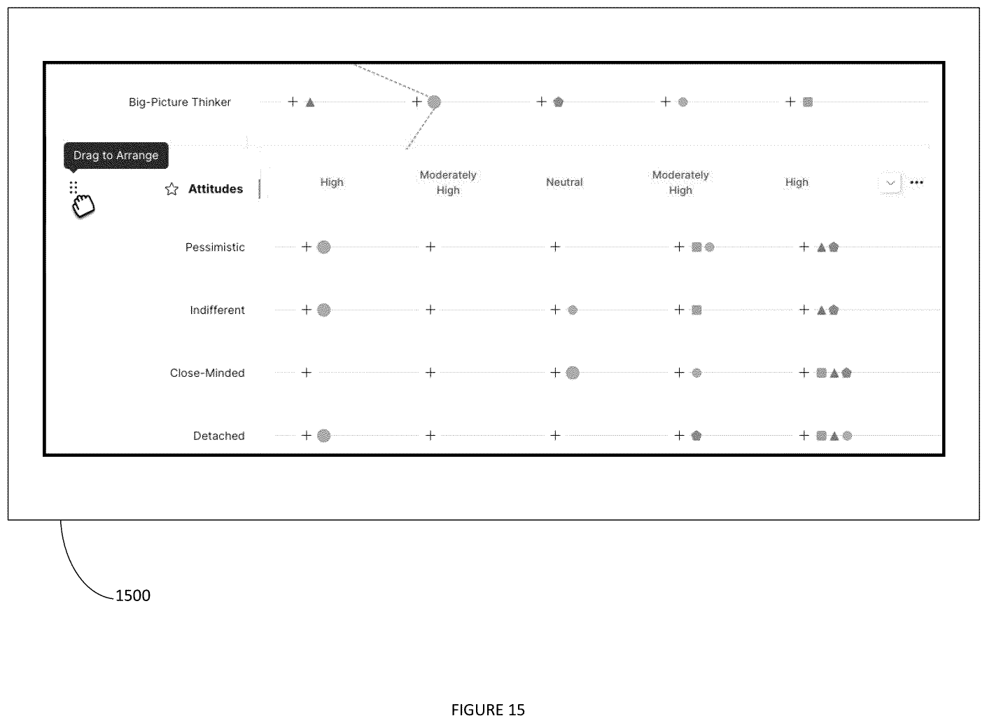

FIG. 15 illustrates an example Section Position Change screenshot 1500, according to some embodiments. The position of an entire section can be altered by utilizing a drag-and-drop operation or clicking the move up or down interaction from the section menu, relocating the section to a different position among other sections. When such repositioning occurs, the line segments connecting the attributes within that section to the entity marker icons for all entities are adjusted accordingly.

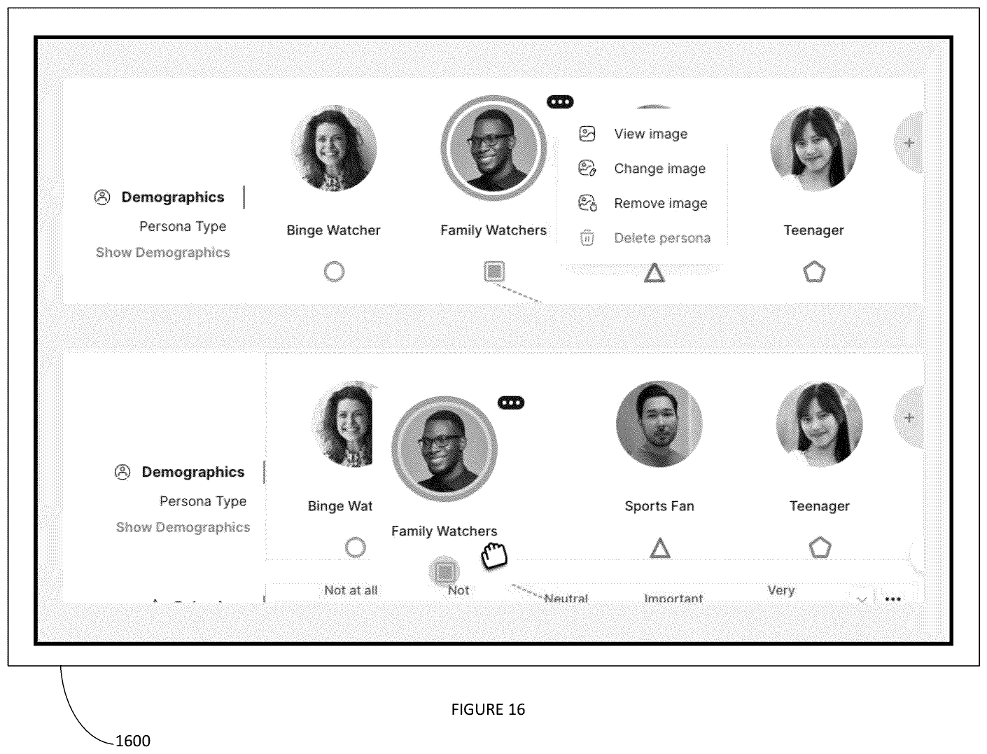

FIG. 16 illustrates an example Entity Position Change screenshot 1600, according to some embodiments. The position of an entity can be changed by employing a drag-and-drop operation or using the move right-or-left or rearrange interaction from the entity menu, where the entity is moved to a new position among other entities. Upon this repositioning, the origin point represented by the entity marker icon of the connecting line for that entity is also shifted to match the new position of the entity. Also, the position of the marker icons on each attribute scale takes the new position amongst other shapes corresponding to the order of the entities on the top.

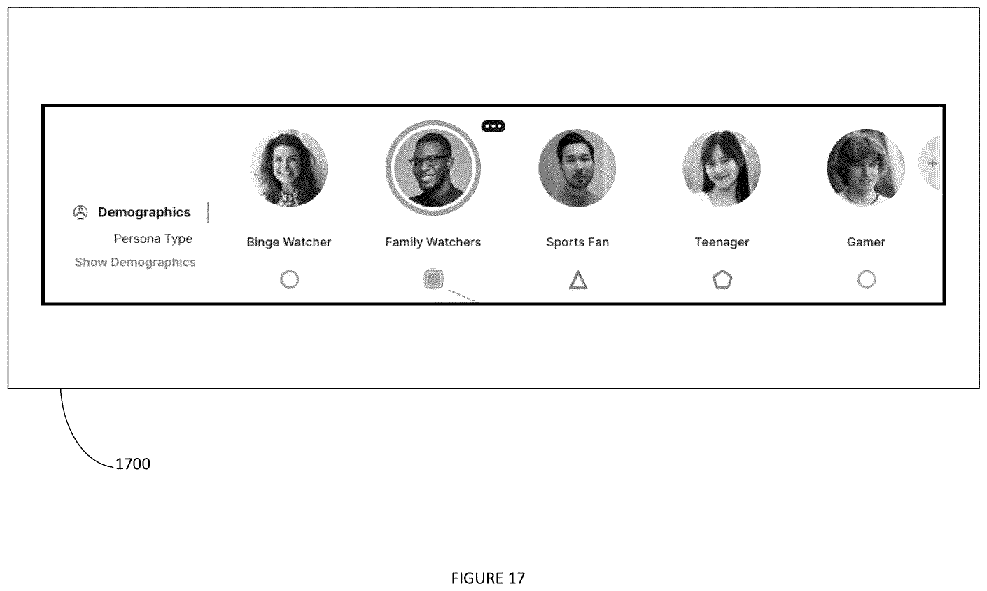

FIG. 17 illustrates an example Visual Representation for Entity screenshot 1700, according to some embodiments. As noted above, each entity has an image known as entity icon, entity details and some attributes (e.g. Tasks, Goals) of the entity and an entity marker icon. The entity icon and attributes are ordered horizontally at the top of the mapper. Together, the entity icon, entity details and entity marker icon can be called the Demographics Section. In the event that all entities cannot fit on the screen, the entity section is made horizontally scrollable. This allows users to view all entities, even if they exceed the width of the screen. Also, if the demographics section becomes too tall it can be collapsed and expanded with an expand-collapse icon.

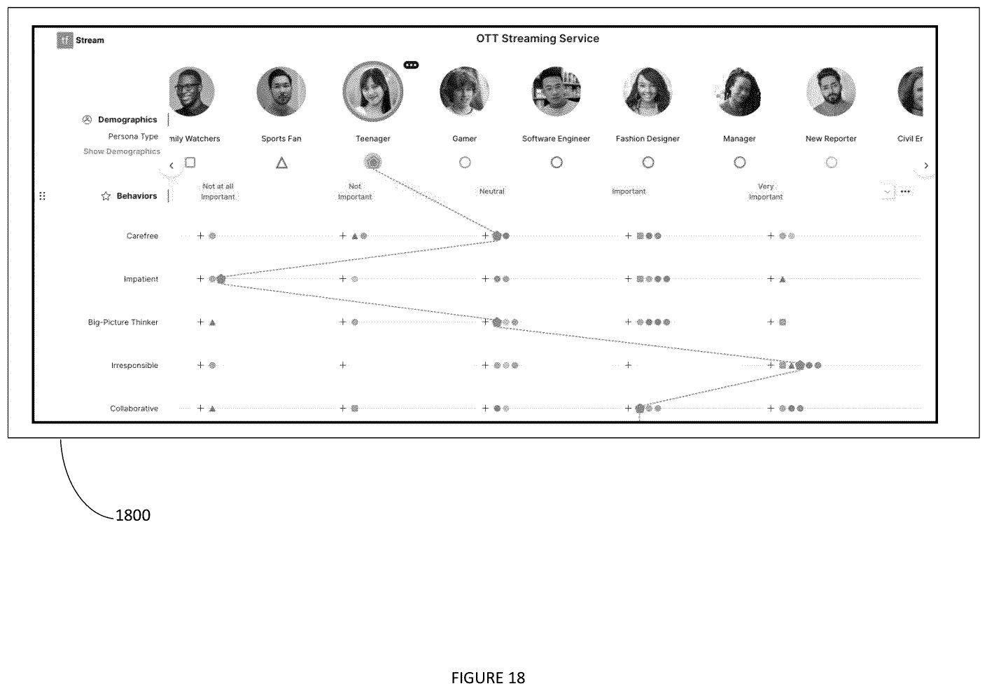

FIG. 18 illustrates an example screenshot 1800 showing scrolling of entities horizontally, according to some embodiments. As shown, in FIG. 18 when the entity section is scrolled, the line segments that connect the entity marker icons to the first attribute scale value for all entities also move in the direction of the scroll. If the entity section is scrolled past the left or right boundary of the mapper, the line segments that connect the entity marker icon to the first attribute scale value for all entities also move past the boundary. The portion of the line segments that are outside of the mapper boundary are clipped, or hidden, from the visible mapper page.

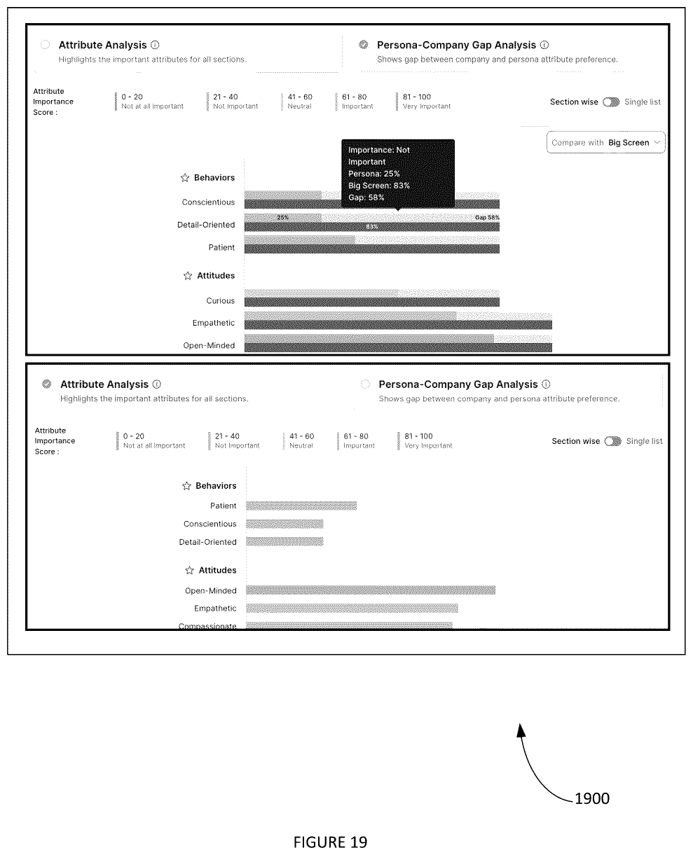

FIG. 19 illustrates an example screenshot 1900 showing the Attribute Analysis, according to some embodiments. In attribute analysis, we use a mathematical approach to determine the relevance and significance of different attributes. A step-by-step explanation of the process is now provided:

1. Assigning Weights: Each attribute scale value is assigned a weight W, starting from 1 up to V. V represents the number of values on a scale (for example, if one scale has 5 values, then W would range from 1 to 5). The maximum value of W is equal to V. An attribute at position v will have a weight of v. These weights reflect the relative importance of each attribute scale value.

2. Calculating Attribute Importance Score: To get the Attribute Importance Score (AIS) we then multiply the weight (ranging from 1 to V for one-sided attributes and V, V−1, . . . , V−1, V for two sided attributes) with the number of entities that have selected that particular attribute scale value for each attribute. For example, let's say we have 6 entities or items, and 2 of them correspond to value 2 (e.g. Not Important), while 3 correspond to value 4 (e.g. Important). The entity that has not been allotted any attribute scale value for an attribute will have a weight of 0. To calculate the importance score for this attribute, we perform the following calculation: 2*2+3*4+1*0=16. The resulting score quantifies the importance of the attribute, where a higher score indicates greater importance. An attribute importance score (AIS) is also normalized on a range of 1 to 100. So, if there are N entities or items for which the attributes are mapped on a scale with V values, then the maximum possible AIS will be T=N*V. We calculate the normalized attribute importance score is equal to (AIS/T)*100.

3. Calculating Attribute Relevance Score: To get the Attribute Relevance Score (ARS) we count the number of entities that have selected any attribute scale value for each attribute. Taking the previous example, let's say we have 6 entities or items, and 2 of them correspond to value 2 (e.g. Not Important), while 3 correspond to value 4 (e.g. Important). To calculate the relevance score for this attribute, we count the number of entities that have selected any attribute scale value i.e. 2+3=5. Then we divide this number by the total number of entities in the entity mapper. The final Attribute Relevance Score for this attribute will be: 5/6. So, if there are N total entities in the entity mapper, and n entities out of these have selected any attribute scale value for this attribute, then the Attribute Relevance Score will be: n/N.

4. Calculating Final Attribute Score: The final score of each attribute is the weighted mean of the Attribute Importance Score and Attribute Relevance Score. The weight of each score can be changed to prioritize any one type of score over another. Let's say the score weight of Attribute Importance Score is SW1, and the score weight of Attribute Relevance Score is SW2. The final attribute score will be calculated as: SW1*AIS+SW2*ARS.

5. Sorting Attributes: Once the final attribute importance scores are computed for all attributes, we can sort them based on their respective scores. There are two sorting options available:

a. Section-wise Sorting: In this option, attributes are sorted within their specific sections. The attributes within each section are arranged in descending order from the highest score to the lowest. This approach allows for an evaluation of attribute relevance within each section, providing a clear understanding of the most significant attributes within that section.

b. Overall Sorting: Alternatively, we can sort the attributes across the entire mapper, disregarding their individual sections. Here, the sorting is solely based on the final attribute importance scores, allowing us to assess the overall significance of attributes irrespective of the sections to which they belong. This method provides a comprehensive view of the relative importance of attributes throughout the entire mapper.

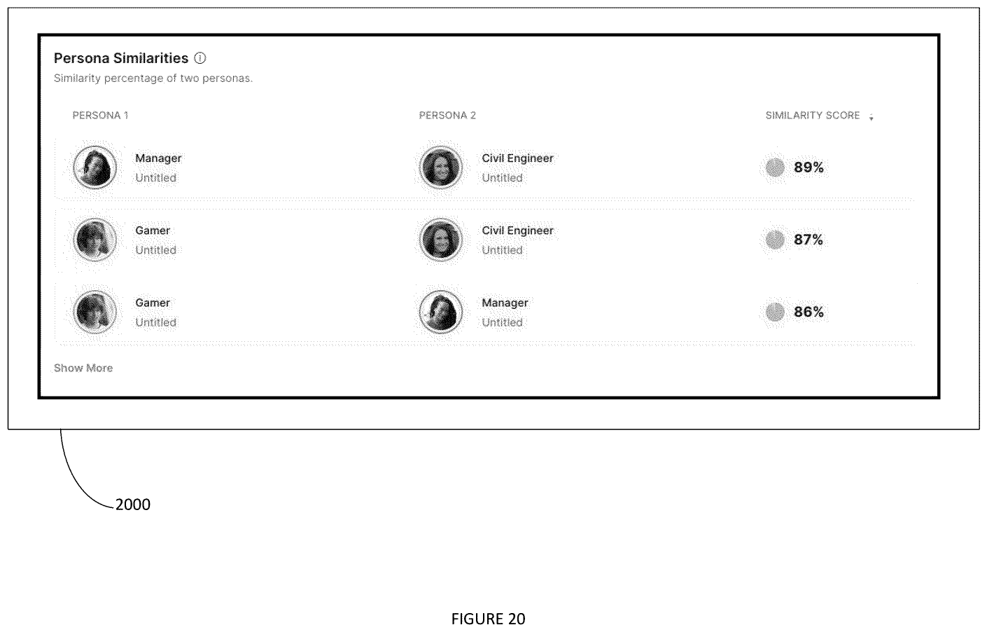

FIG. 20 illustrates an example Similarity Analysis screenshot 2000, according to some embodiments. In the process of similarity analysis, the goal is to find the entities that are most similar to each other. A breakdown of the steps involved in this analysis is now provided:

1. Pairing: Each entity or item in the mapper is paired with all other entities except itself. This means that each entity will be compared to every other entity. So, if there are N entities or items, the total number of comparisons that will be run in the system will be N*(N−1)/2. In this case, we are comparing two entities at a time, however, this entire similarity analysis logic and representation can be extended to know the similarity between more than two entities at a time.

2. Weight Difference Calculation in an Entity Pair for each Attribute: In order to assess the similarity between entity pairs, the following process is used. Each attribute scale value is assigned a weight W, starting from 1 up to V. V represents the number of values on a scale (for example, if one scale has 5 values, then W would range from 1 to 5). The maximum value of W is equal to V. An attribute at position v will have a weight of v. Then we calculate the absolute Weight difference by subtracting the weight of the selected Attribute Scale Values for each attribute in the entity pair being compared. The maximum weight difference for each attribute will be V−1, where V is the total number of values on the scale. We now sum up the absolute weight differences of each attribute for each entity pair, which is a number D. This calculation provides a quantitative measure of the dissimilarity between the entity pairs. A lower total D indicates a higher level of similarity between the entities in the pair. A similarity score (SS) or percentage is calculated on a range of 1-100. So, if there are M attributes on a scale with V values, the highest possible score of D is M*(V−1), and the lowest possible score of D is M*0, which is 0.

So, the similarity score will be SS=100−(D/M*(V−1))*100).

3. Sorting and Display: Once we have calculated the Similarity Scores for all entity pairs, we sort the pairs in descending order based on their Similarity Score. This sorting allows us to identify the entity pairs with the highest similarity. The most similar entity pairs will be listed at the top of the sorted list.

4. Top K Matches Displayed: Finally, we display the top K similar entity pairs. The value of K represents the desired number of top matches that we want to display. The maximum value of K will be the total number of possible entity pairs. These pairs are ordered in the highest degree of similarity.

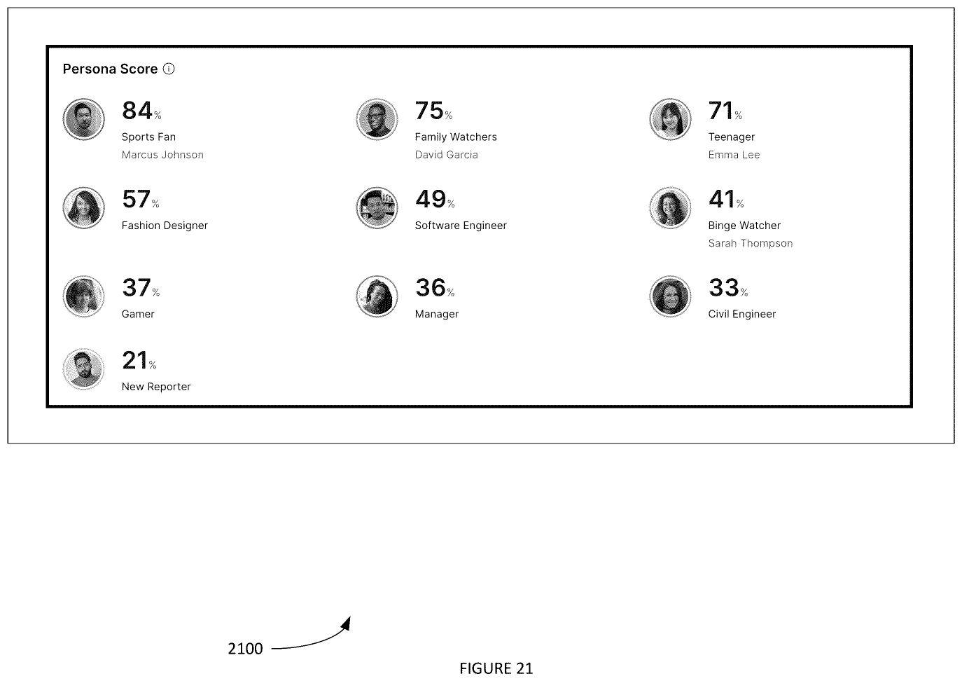

FIG. 21 illustrates an example Entity Score Analysis screenshot 2100, according to some embodiments. The objective of the score analysis process is to rank entities based on the number of attribute scale values they have selected throughout the entire entity mapper, thereby identifying the most relevant entities. A breakdown of the steps involved in this analysis is now provided:

1. Assigning Weights: Each attribute scale value is assigned a weight W, starting from 1 up to V. V represents the number of values on a scale (for example, if one scale has 5 values, then W would range from 1 to 5). The maximum value of W is equal to V. An attribute at position v will have a weight of v. These weights reflect the relative importance of each attribute scale value.

2. Calculating Score: The Total Entity Score (TES) is calculated as follows. For each entity, the entity score is calculated by taking the sum of all the weights assigned to all the attribute scale values selected by that entity. Then this score is normalized on a range of 1 to 100. So if there are N total attributes in the entity mapper for which the attributes are mapped on a scale with V values, then the maximum possible TES will be: T=N*V. We calculate the normalized Total Entity Score as (TES/T)*100.

Sorting and Display: Once we have calculated the Total Entity Score for all the entities, we sort the entities in descending order based on their Total Entity Score. This sorting allows us to identify the most relevant entities in the Entity Mapper.

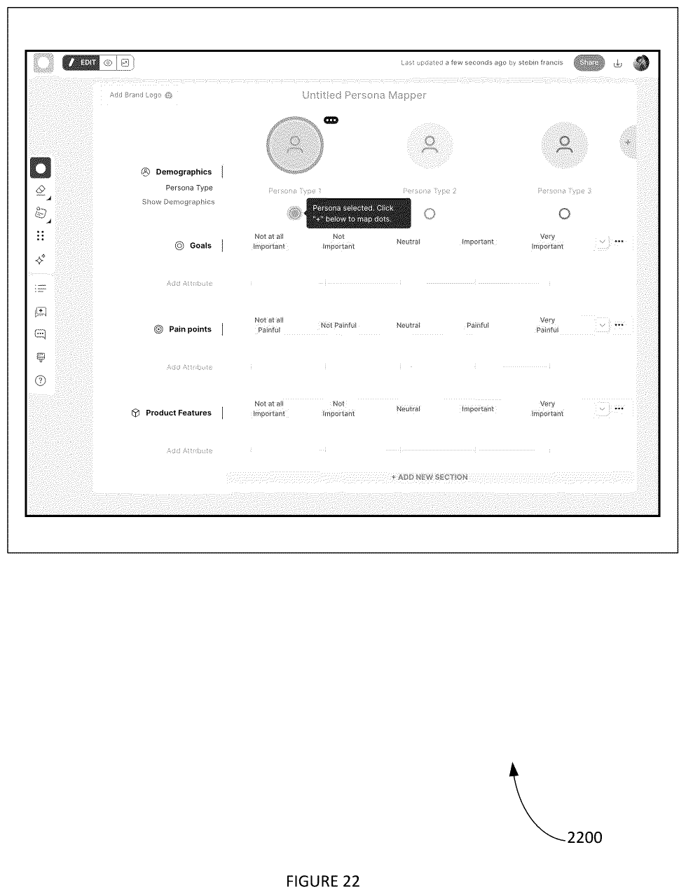

FIG. 22 illustrates an example screenshot 2200 of a template that can be a starting point for the user to begin creating their mapper, according to some embodiments. After a user creates a new mapper, the first screen of interaction can be a template or an empty mapper that provides a starting point for the user to begin creating their mapper. The template includes entity placeholders, as well as sections relevant to the type of mapper that is being created, e.g. consumer mapper, enterprise mapper, buyer mapper, behavioral mapper, journey mapper etc. These sections can be edited or deleted as needed, and the user can add additional sections as desired. The sections and attributes in each template are intended to represent the different types of preferences generally found in these types of entities. For example, a default consumer entity mapper would include sections and attributes pertaining to preferences of users of consumer products (e.g. e-commerce buyers, etc.). The sections in the template are intended to gather different goals, needs, pain points, etc. for the entities.

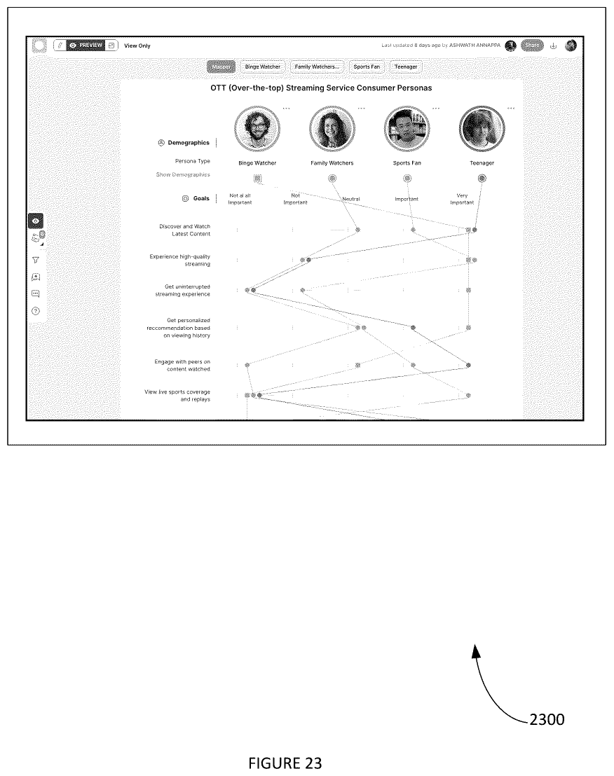

FIG. 23 illustrates example screenshots 2300 of an Entity Mapper report, according to some embodiments. The report page provides a view-only interface of the mapper. It can be updated in real time with any changes made to the mapper. The view can be filtered by limiting it to certain entities or tag(s) or Assigned to lists in the mapper. This allows users to view the latest changes to the mapper and to focus on specific areas of interest. The attributes within the section can also be sorted based on the Attribute Score or Gap Score from the Sort By dropdown. If sorted by Gap Score, any one entity can be selected from the filters, which will result in calculation of gap score of all entities with the selected entity. The sorting can be done in both Ascending and Descending Order.

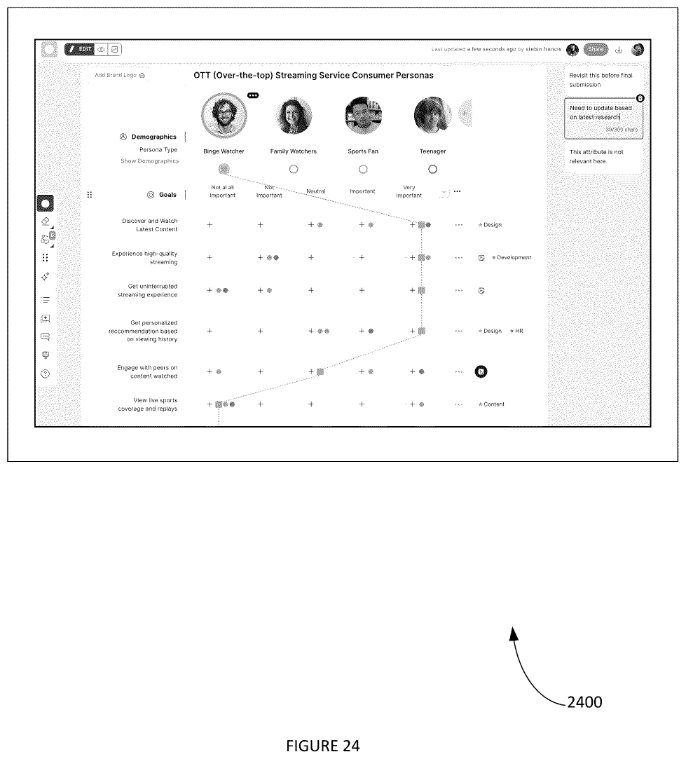

FIG. 24 illustrates an example screenshot 2400 of an entity mapper, according to some embodiments. Using the entity mapper a user can add entities, details, attributes, sections, scales, etc. on their own using text or media entries, or from the provided libraries, or using the provided services (e.g. AI, etc.). The user can map all entities against different attributes on the created scales. Further the user can add a status, note, sticky note, picture, image, comment, etc., to each attribute or section. The statuses such as Pending, Important, Urgent, etc. can be used to track the progress of an entity or attribute and to prioritize the work that needs to be done. The user can further assign each attribute or section to a person, department, etc. to take action using the ‘Assign to’ interaction provided in the attribute, section and entity menu.

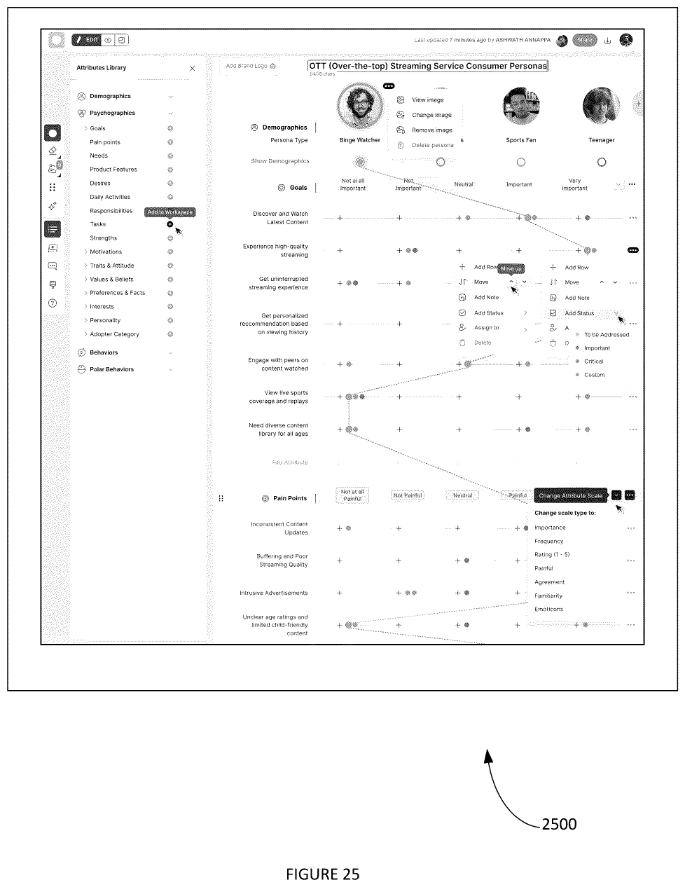

FIG. 25 illustrates an example screenshot 2500 of the Attributes library provided by the mapper tool, according to some embodiments. The user has access to a large library of attributes that can be used to create and customize entities. The library contains attributes relevant to many different types of entities, including, inter alia: demographic information such as age, gender, location, and education level; work-related information such as job title, industry, and years of experience; personal interests and hobbies; goals and aspirations; challenges and barriers; etc. Selecting a category from the attribute from the library will add a new section with that name in the entity. Selecting an attribute from the library will add that attribute in the associated/created section.

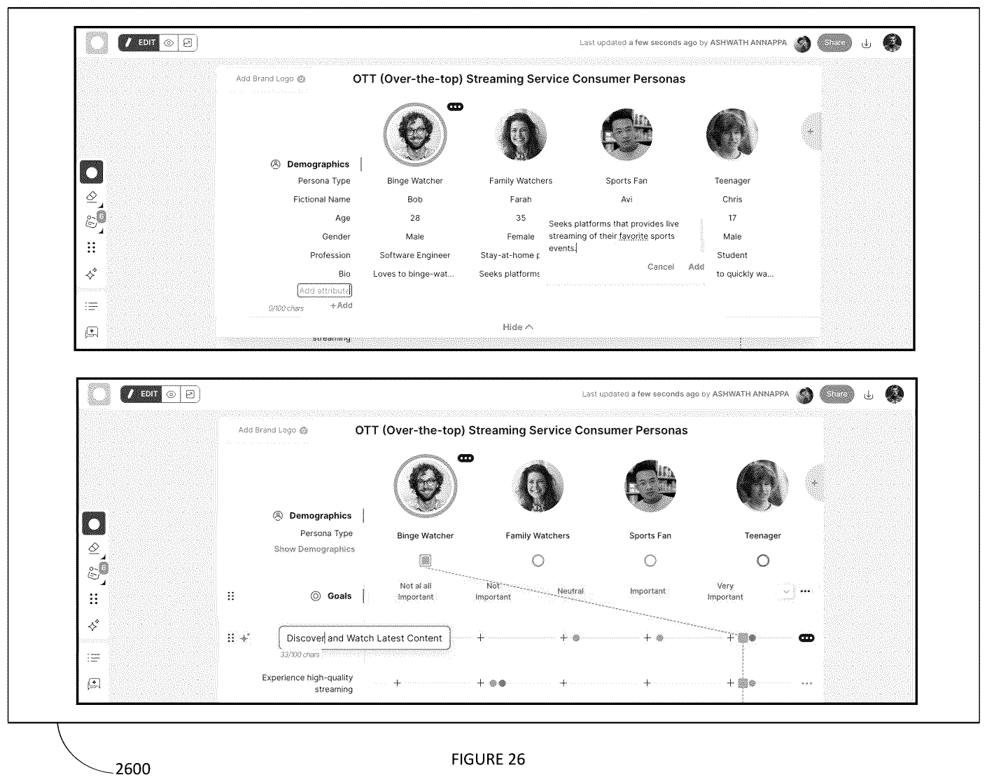

FIG. 26 illustrates an example screenshot 2600 that represents accessing additional information for an entity, according to some embodiments. The entities themselves have information about the different aspects of their work, preferences and lives. This information can be used to help the user understand the entity's needs, goals, tasks, preferences, motivations, etc. and to create a more user-friendly experience.

For example, for an e-learning platform, an entity that is a stay-at-home parent with young children might have different needs than an entity that is a single professional. Another entity of type company is a competitor e-learning platform that might have certain features that the current company entity does not have. By understanding the different entities being mapped, the user can create a more personalized experience that meets the needs of each entity type or individual in their e-learning platform.

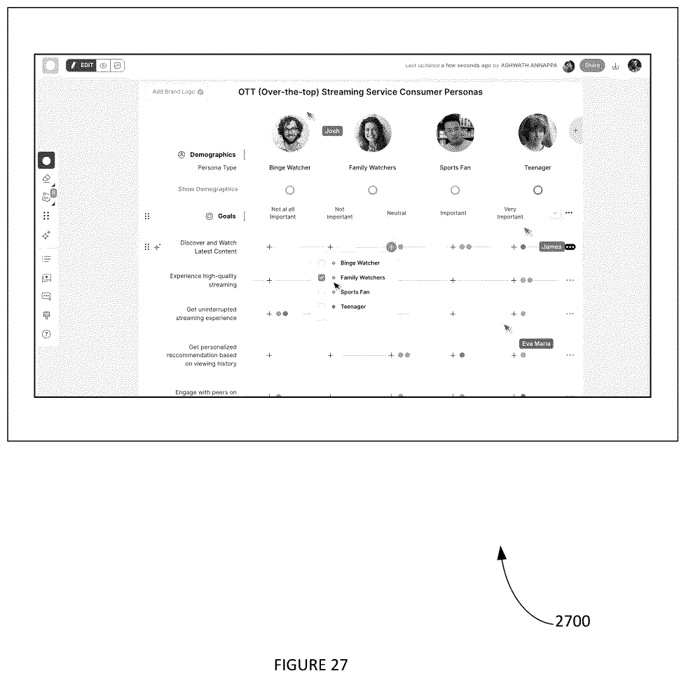

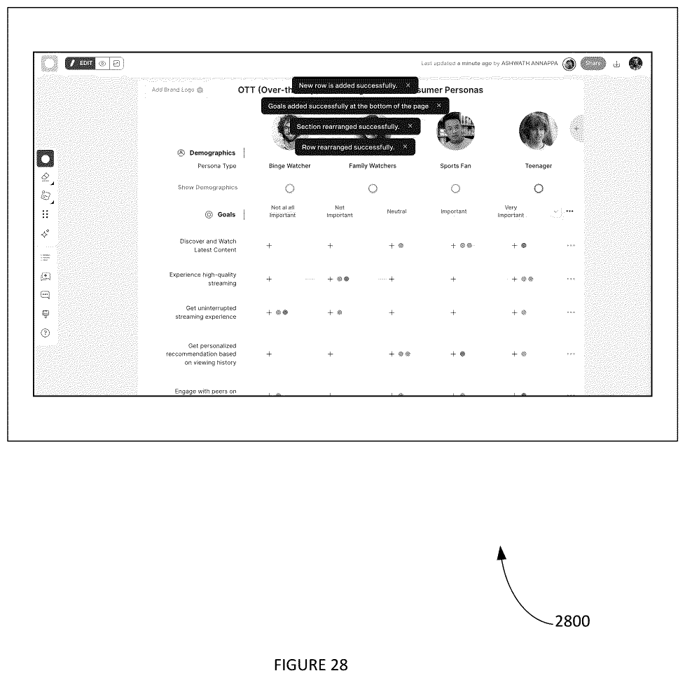

FIG. 27 illustrate screenshots 2700-2800 showing editing operations, according to some embodiments. All editors can view editors who are online in real time and can view edits made by other editors in real time. This allows editors to work together to create a high-quality document that reflects the input of all team members. When an editor makes a change to a document, it is automatically saved and all other editors who have access to the document will see the change immediately. This ensures that everyone is working on the same version of the document.

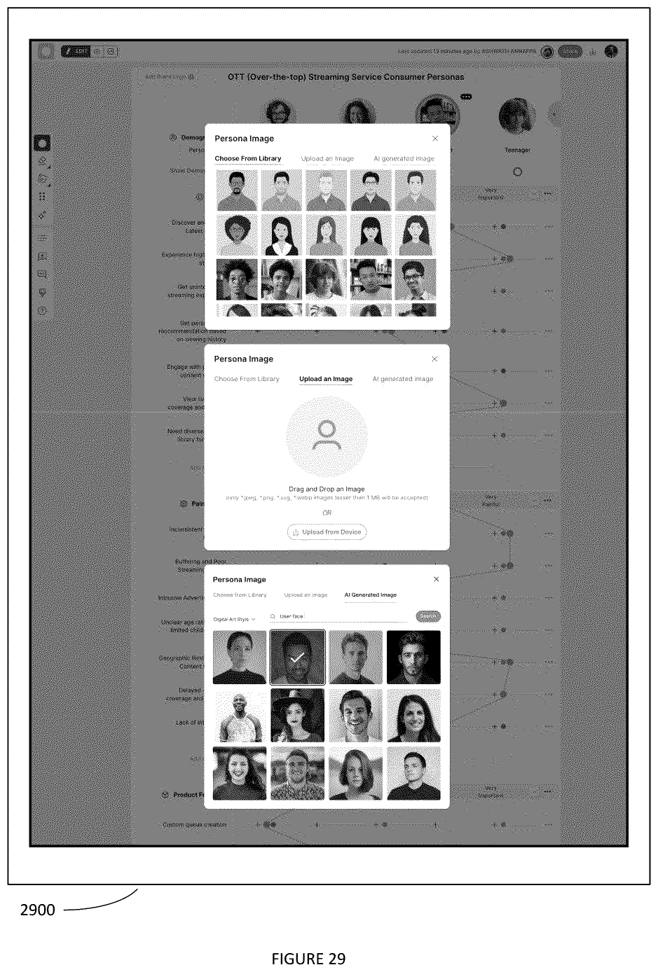

FIG. 29 illustrates an example screenshot 2900 of entity image management, according to some embodiments. Each entity will be represented by an image known as entity icon that reflects their appearance. The entity image can be selected from a large collection of entity images and/or it can be generated by an AI image-creation tool. Users also have the option to upload their own custom images. This flexibility allows users to create entities that are both visually appealing and accurately represent their target audience.

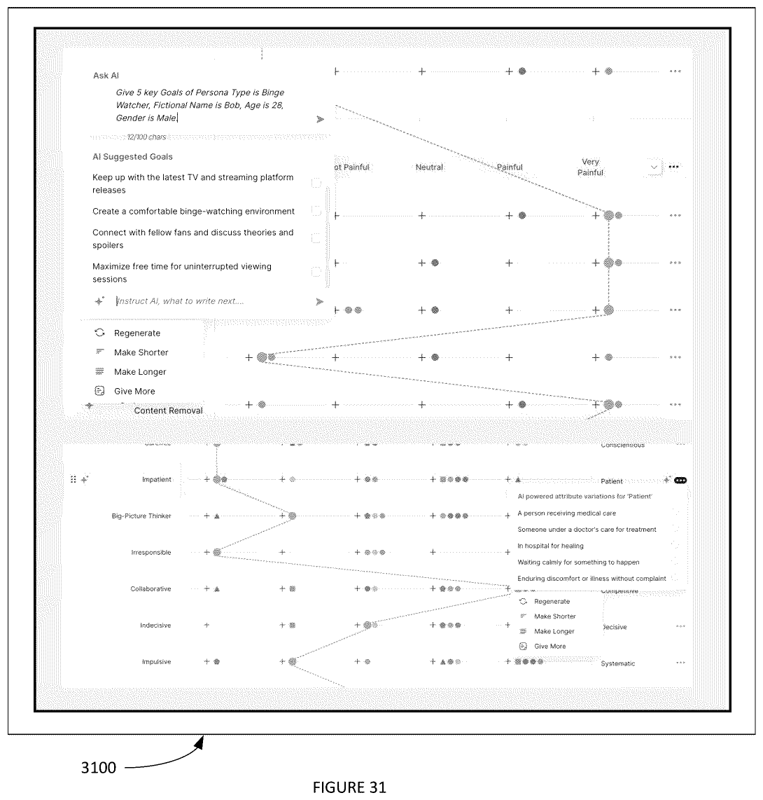

FIG. 31 illustrates an example screenshot 3100 that demonstrates the use of AI in the Entity Mapper. Ask AI (Artificial Intelligence) can be used to generate attributes in the entity mapper, according to some embodiments. Asking AI feeds the AI engine with the demographic data such as (age, gender, role, responsibility, bio, etc. . . . ) of each entity along with the section name (e.g. Goals, Motivations, Tasks, Challenges, etc. . . . ). The user can also edit the input being fed to the AI engine. The AI responds back with attribute suggestions for each section that the user can choose to import and use in the mapper. The user can additionally Ask AI to regenerate, make shorter, make longer or get more attribute suggestions.

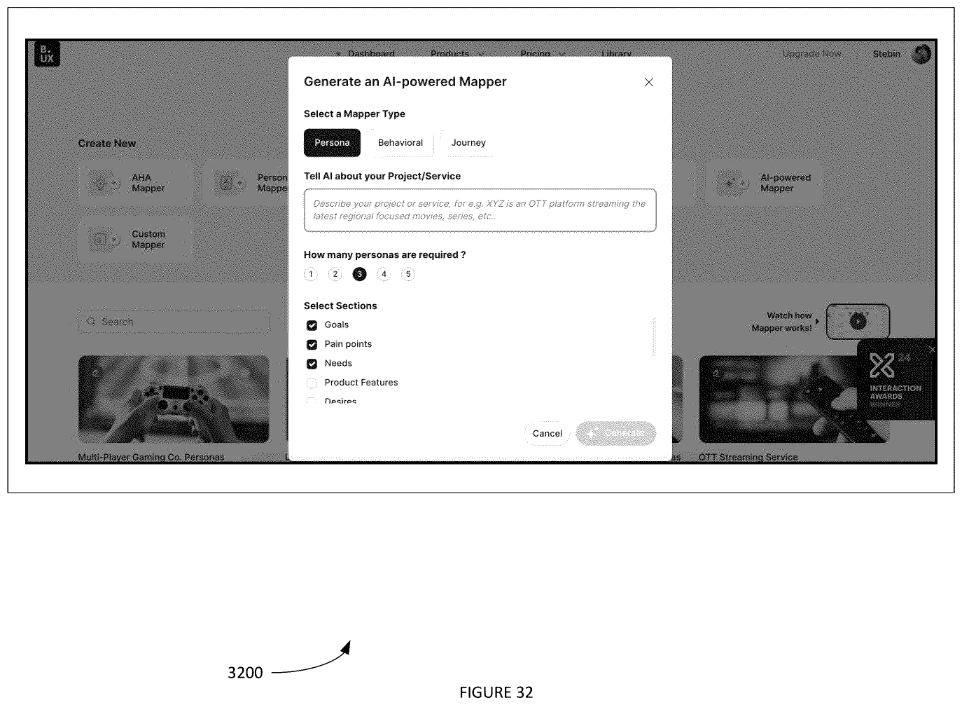

FIG. 32 illustrates an example screenshot 3200 of a view used to generate an entity mapper using AI. This view is activated by clicking on the AI Powered Mapper button. The process involves the following steps:

1. Select predefined fields: The type of Entity Mapper to be generated is selected from the available types. Based on this selection, the list of available sections will adjust accordingly to be relevant to the selected type of entity mapper. The required sections are then selected. Additionally, the number of entities to be generated in the entity mapper is also selected.

2. Describe the Entity Mapper: A brief description of the entity mapper to be generated is provided.

The AI Engine then follows this process to generate the entity mapper:

1. The AI Engine processes the input provided and generates a list of relevant entities based on the entity mapper description. For each entity, additional demographic information is also generated.

2. Based on the generated entities and the provided description, the AI Engine generates attributes for the selected sections that are relevant to the description.

Attribute scale values for the generated entities and section attributes are determined in this step. This step is optional. If not skipped by the user, the AI Engine will attempt to find the most relevant attribute scale value for each entity for each attribute.

After all data is generated by the AI Engine, the mapper is created using the generated entities, section attributes, and attribute scale values, which are mapped based on the generated data. While the AI Engine is generating the mapper, attempting to open the mapper will prompt a popup alerting the user that the AI Engine is still processing the mapper.

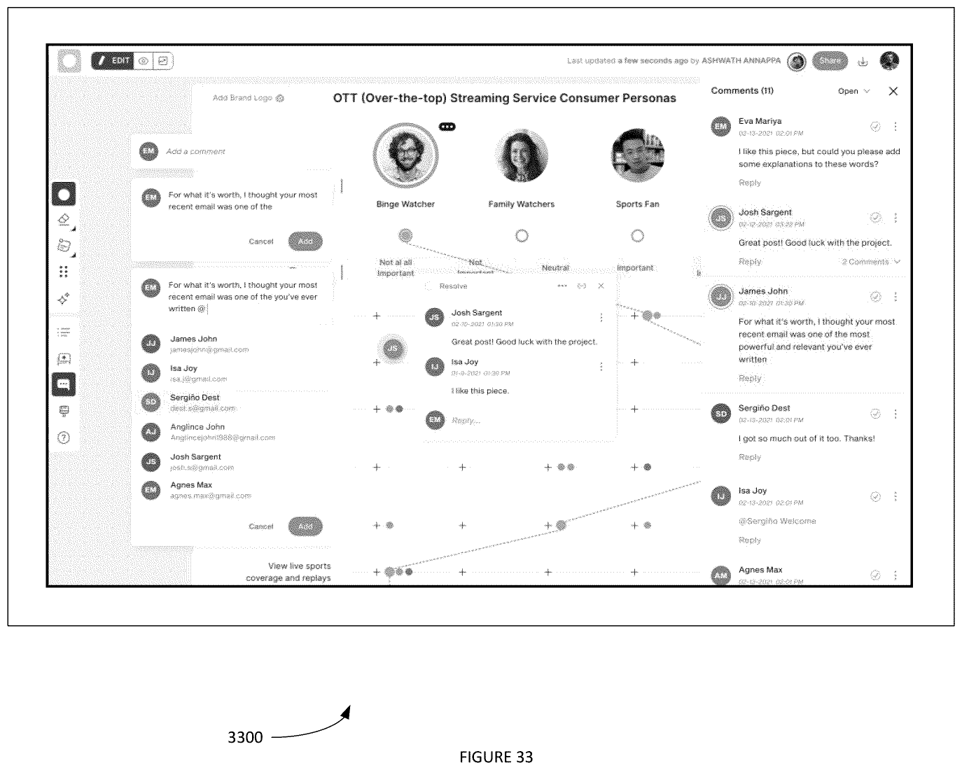

FIG. 33 illustrates an example screenshot 3300 of the Commenting Functionality: Comments can be added anywhere freely in the mapper area, according to some embodiments. The system remembers the coordinates where a comment thread is added and its relationship to each attribute row. This allows users to provide additional context, notes, or discussions related to specific entities, attributes, or their relationships.

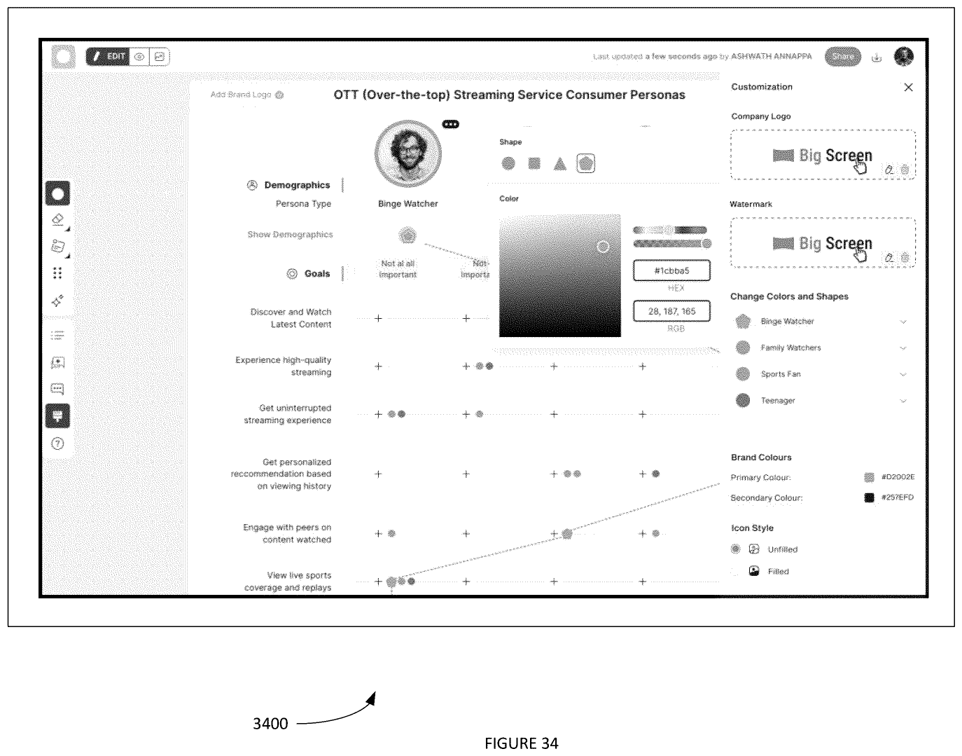

FIG. 34 illustrates an example screenshot 3400 that provides Personalization and Customization features, according to some embodiments. Users can personalize and customize the software by adding logos, applying watermarks, changing entity marker icon colors, changing attribute scale value shapes, incorporating brand colors, and modifying icon styling. These options allow for a customized and branded experience, according to some embodiments.

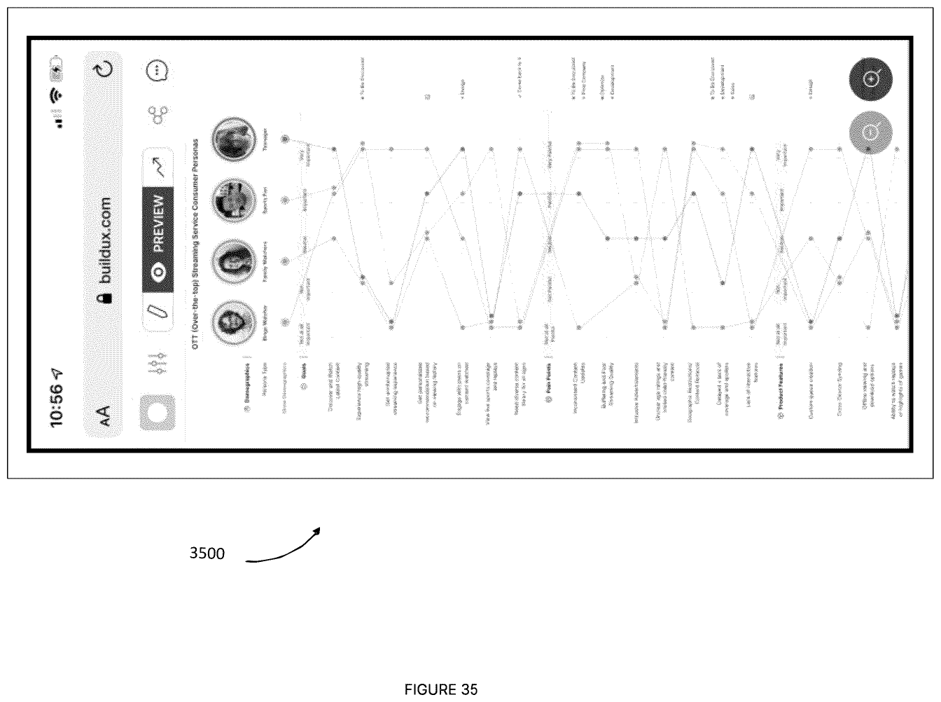

FIG. 35 illustrates an example screenshot 3500 of how the entity mapper looks and works in the mobile view, according to some embodiments.

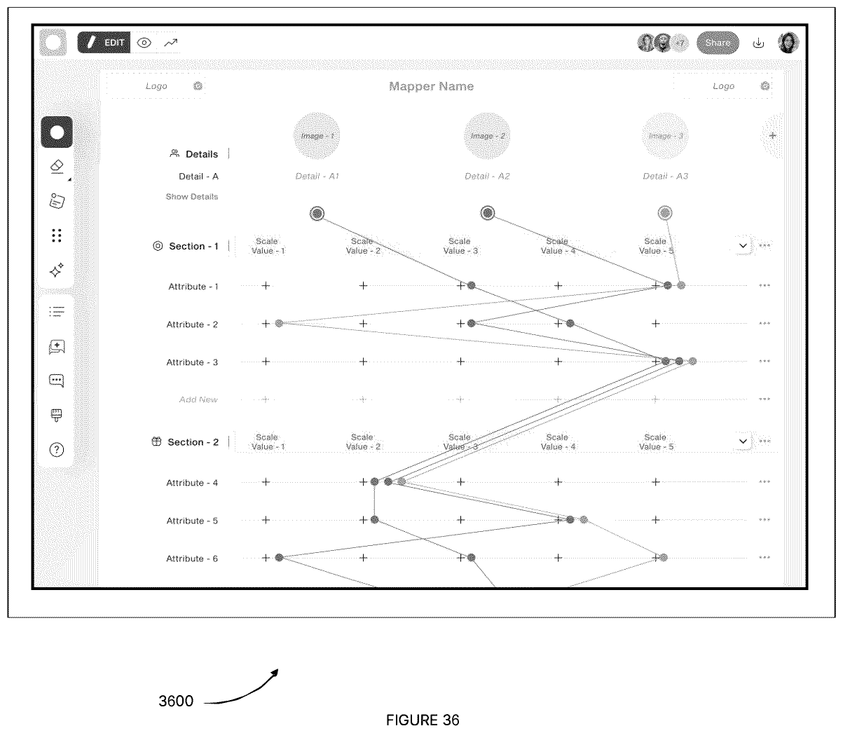

FIG. 36 illustrates an example screenshot 3600 representing that all the interactions and behaviors described for the Entity Mapper are not limited to just mapping entities or user entities, the entity mapper as a system can be used to compare any type and number of entities represented by E1, E2, E3, . . . . En, where Q is the total number of entities with M attributes being mapped on a V value scale, according to some embodiments. For example, the mapper system can be used to compare products with attributes, and each attribute being rated on a scale for each product. Likewise, for example, the mapper can be used to compare brand attributes of multiple products, where each brand attribute is rated on a scale for each product. Also, the attribute analysis, top scorer analysis and similarity analysis between each item is calculated and presented like done for entities. In such use cases the entities are replaced with any type of item being analyzed or compared, according to some embodiments.

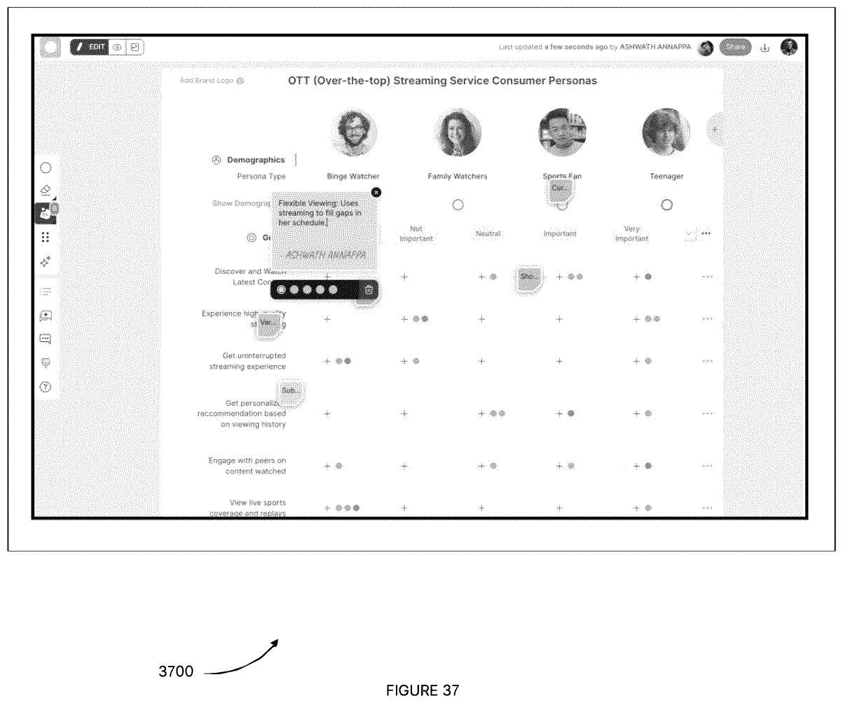

FIG. 37 illustrates an example screenshot 3700 of a sticky note that can be positioned anywhere on the entity mapper edit page or report page. This sticky note serves as a versatile tool for storing various pieces of information. Users can utilize it to jot down notes, reminders, or important details related to their entity mapping activities. The ability to place the sticky note in any desired location on the edit page enhances its convenience, allowing users to tailor the mapper workspace to their specific needs and preferences. This functionality aids in keeping relevant information easily accessible and organized, thereby improving the overall efficiency of the entity mapping process, according to some embodiments.

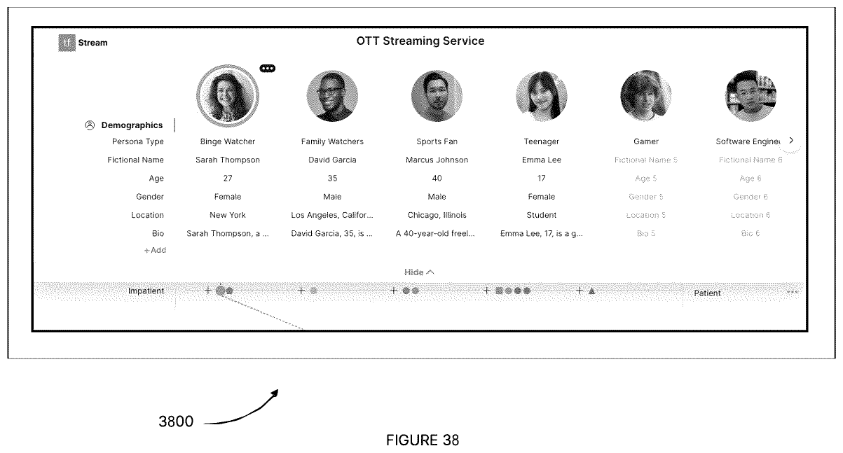

FIG. 38 illustrates an example screenshot 3800 of the demographics section of the entity mapper, which can pop out to emphasize demographic attributes for each entity. This feature is designed to improve the visibility and clarity of each entity's attributes. The pop-out functionality ensures that users can easily access and focus on the demographic details without distraction. By highlighting the attributes prominently, this feature aids in better understanding and analysis of each entity. The enhanced visibility facilitates a more efficient and effective entity mapping process, ensuring that all critical demographic information is readily available and easily interpretable, according to some embodiments.

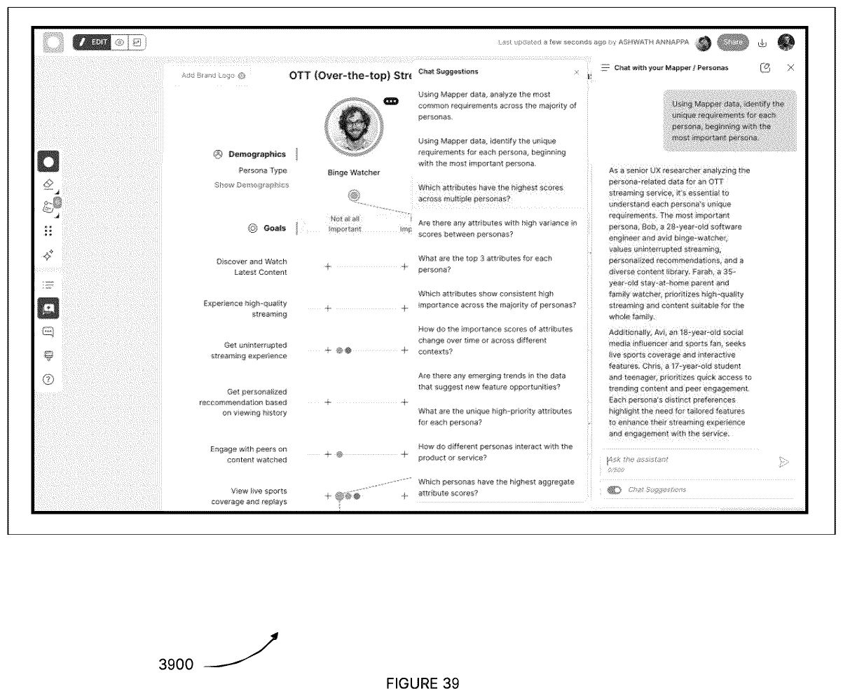

FIG. 39 illustrates an example screenshot 3900 representing the use of AI to chat with an Entity Mapper. AI (Artificial Intelligence) can be utilized to query any aspect of the entity mapper, providing users with an intuitive and efficient way to extract information from the entity mapper. This functionality allows users to ask questions and receive immediate responses, providing a deeper insight into the entity mapper. The integration of AI enhances the user experience by offering a dynamic and interactive approach to entity mapping, ensuring that users can gain valuable insights about the most important entities, sections etc., according to some embodiments.

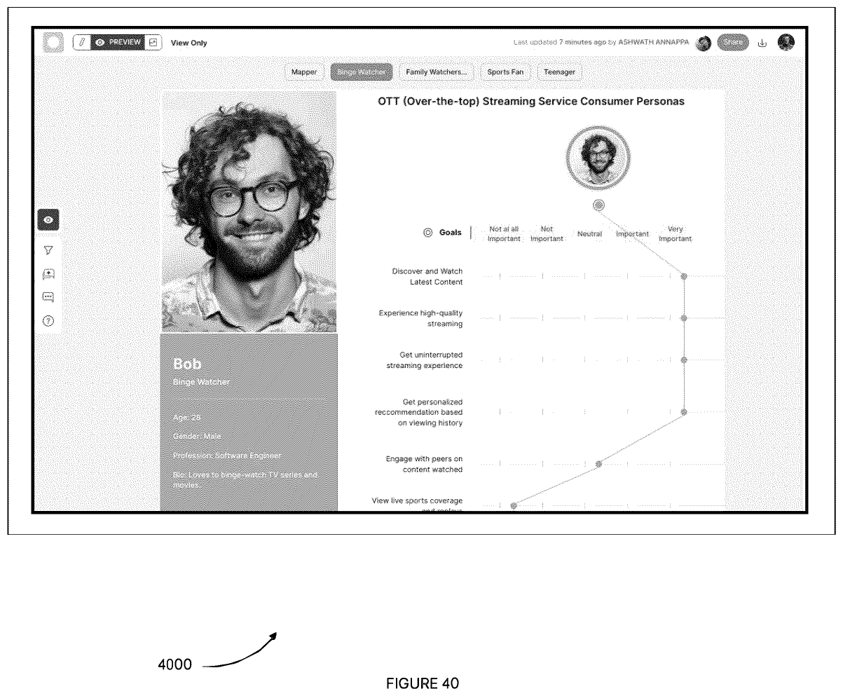

FIG. 40 illustrates an example screenshot 4000 of a separate, highlighted view of the demographics section for a single entity in the entity mapper report. This view improves the visibility and clarity of that entity's image and its associated attributes, of the entity mapping software. The demographics section typically includes key information about the entity. By isolating this data in a dedicated view, users can more easily reference and analyze the demographic profile of each individual entity without having to navigate through the entire entity mapper report, according to some embodiments.

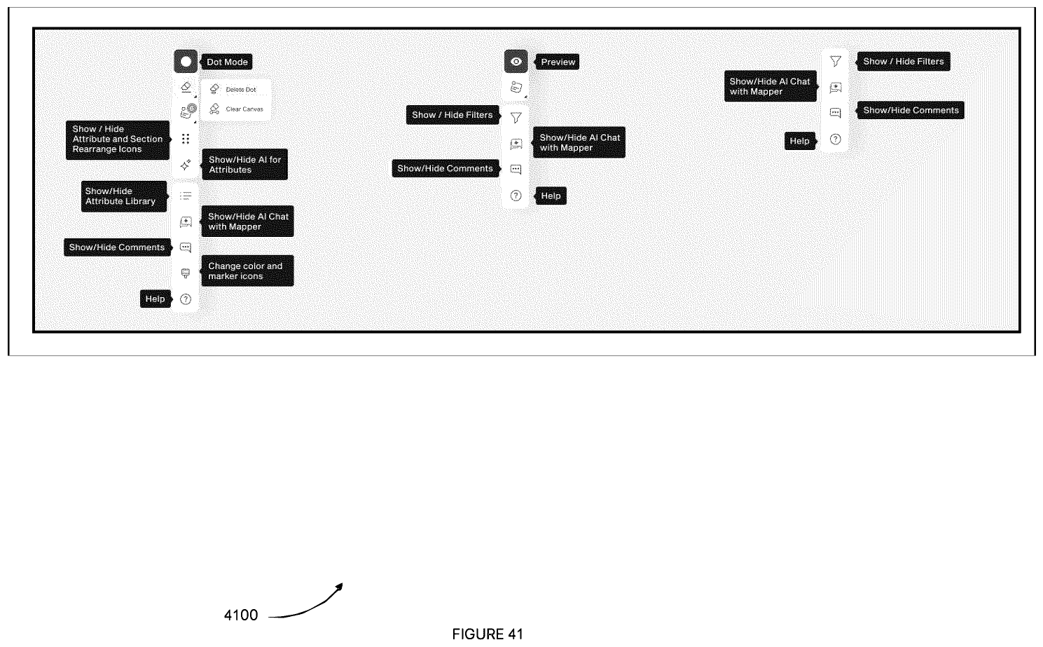

FIG. 41 illustrates an example screenshot 4100 of the different toolbars available on the entity mapper edit and report page. These toolbars are designed to provide quick access to essential operations related to the entity mapper, enhancing the overall user experience of the entity mapper tool. The toolbars consist of important mapper operations that can be performed on the entity mapper, such as adding sticky notes, chatting with the mapper, clearing all mapping, and other key functions. These operations are displayed as icons for ease of use, allowing users to quickly execute the desired action. The toolbars are designed to be context-sensitive, meaning that the available operations change based on the current state of the entity mapper. For example, when a user is on the edit page in the entity mapper, the toolbar will include options to add attributes, clear attribute scale values, whereas when on the report page, the toolbar will include options to filter, sort data, according to some embodiments.

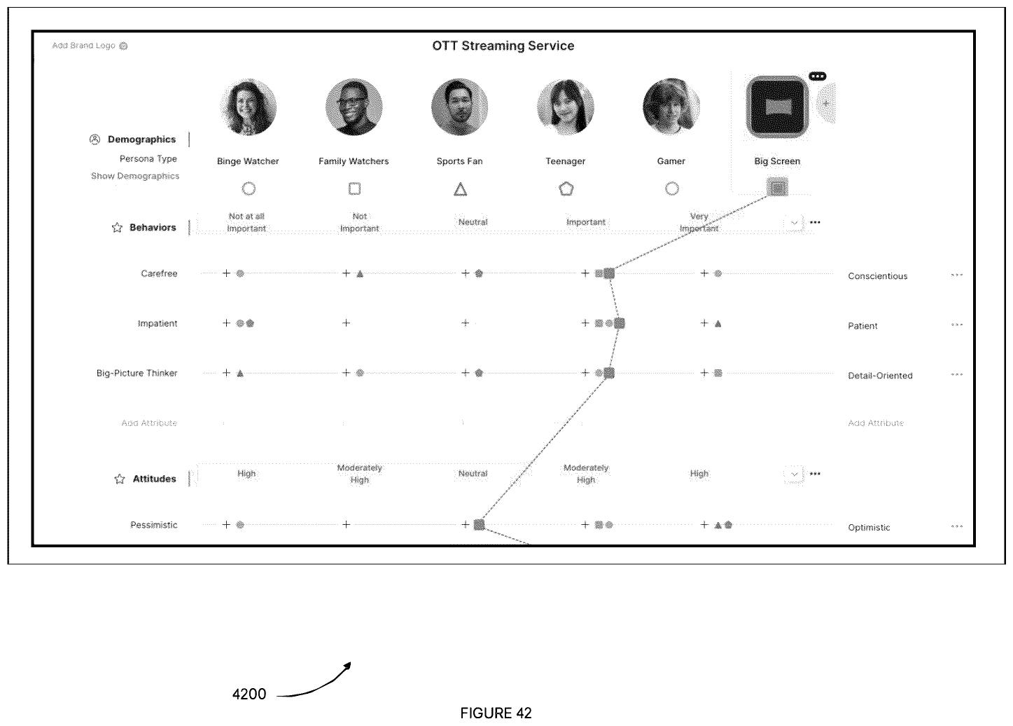

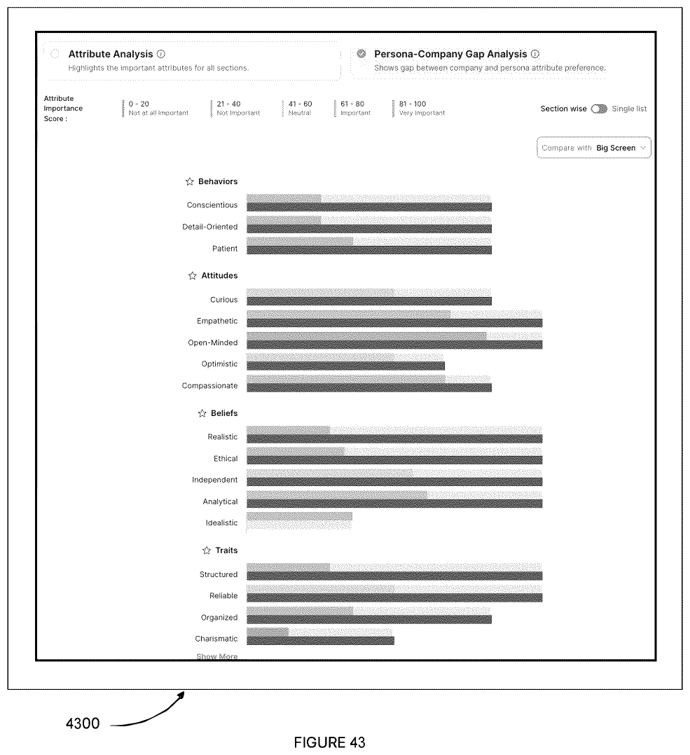

FIG. 42 illustrates an example screenshot 4200 of an entity of type company, which can be used to compare the significance of all entities with the company entity overall attribute scale value mapping. This helps in the identification of certain attributes that may need more attention or focus. The company entity serves as a benchmark or reference point, allowing stakeholders to assess how individual entities within the organization align with the broader organizational entity. By comparing the attributes of a specific entity to the company entity, teams can quickly identify areas of strength, as well as opportunities for improvement or development, according to some embodiments.

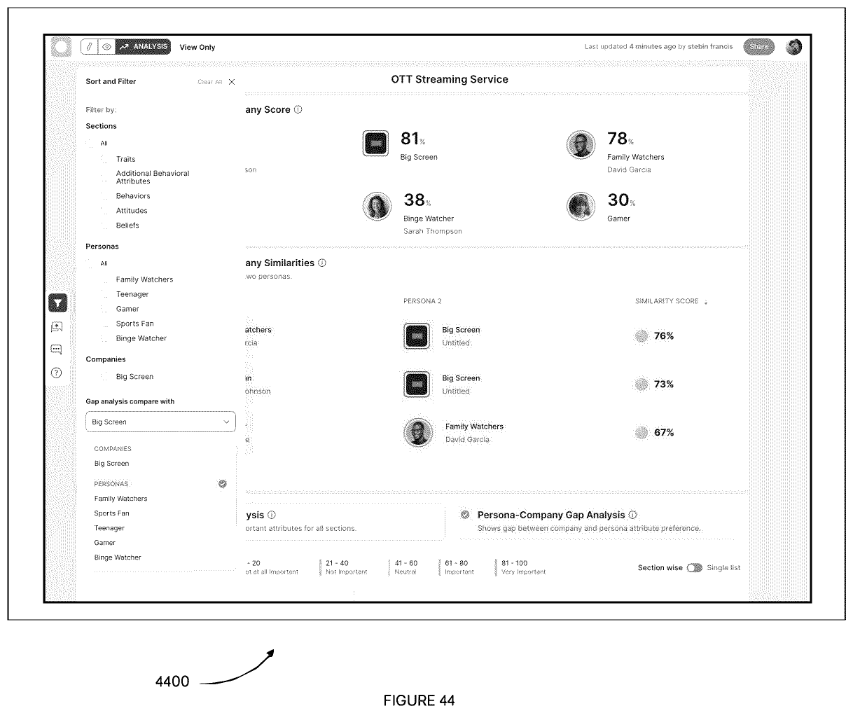

FIG. 44 illustrates an example screenshot 4400 of the Gap Analysis feature within the entity mapper, which compares multiple entities to a reference entity. This visual representation highlights the gaps or differences between the attributes of individual entities and the chosen benchmark entity. The Gap Analysis functionality provides a powerful tool for identifying areas where entities may diverge from the organizational or industry standard. By comparing key attributes such as behaviors, goals, and pain points, teams can quickly pinpoint the most significant discrepancies that may require further investigation or alignment. The visual representation of these gaps is particularly valuable, as it allows stakeholders to easily identify patterns, outliers, and areas of concern at a glance. The entity mapper presents this information in a clear, intuitive format, using color-coding to indicate the magnitude and direction of the gaps, according to some embodiments.

FIG. 45 illustrates an example screenshot 4500 of the use of a dropdown menu within the entity mapper to select any entity for conducting Gap Analysis on multiple entities. This feature allows users to choose the reference point against which they want to compare their entities, enabling a more targeted and insightful analysis. The dropdown menu presents a list of available entities of different types, making it easy for users to quickly identify and select the desired benchmark. For example, a user might choose to compare multiple entities of any type against any other entity of type persona, or company, to assess how other entities measure up to this benchmark entity, according to some embodiments.

### Additional Computing Systems and Methods

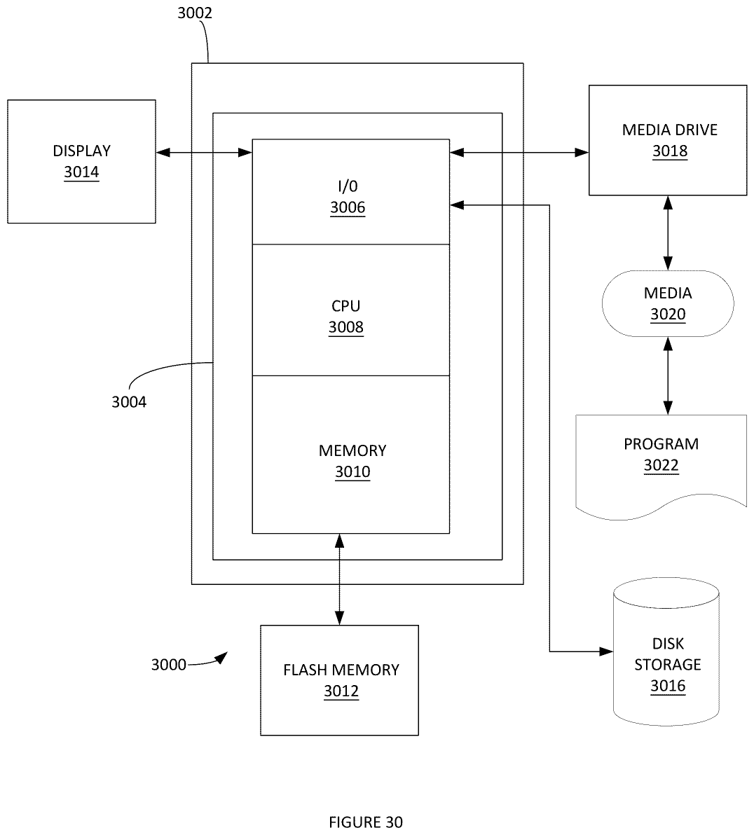

FIG. 30 depicts an exemplary computing system 3000 that can be configured to perform any one of the processes provided herein. In this context, computing system 3000 may include, for example, a processor, memory, storage, and I/O devices (e.g. monitor, keyboard, disk drive, Internet connection, etc.). However, computing system 3000 may include circuitry or other specialized hardware for carrying out some or all aspects of the processes. In some operational settings, computing system 3000 may be configured as a system that includes one or more units, each of which is configured to carry out some aspects of the processes either in software, hardware, or some combination thereof.

FIG. 30 depicts computing system 3000 with a number of components that may be used to perform any of the processes described herein. The main system 3002 includes a motherboard 3004 having an I/O section 3006, one or more central processing units (CPU) 3008 and/or graphical processing unit (GPU), and a memory section 3010, which may have a flash memory card 3012 related to it. The I/O section 3006 can be connected to a display 3014, a keyboard and/or another user input (not shown), a disk storage unit 3016, and a media drive unit 3018. The media drive unit 3018 can read/write a computer-readable medium 3020, which can contain programs 3022 and/or databases. Computing system 3000 can include a web browser. Moreover, it is noted that computing system 3000 can be configured to include additional systems in order to fulfill various functionalities. Computing system 3000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Various similarity measures can be utilized to measure similarities between entities. For example, k-nearest-neighbor operations can be used. Cluster analysis can be used as a data mining technique to discover patterns in data by grouping similar objects together. Cluster analysis can partition a set of data points into groups or clusters based on their similarities. Cluster analysis can measure similarity between data points (e.g. data points that comprise an entity, etc.). Similarity measures play a crucial role in many clustering techniques, as they are used to determine how closely related two data points are and whether they should be grouped together in the same cluster. Similarity measures can take many different forms depending on the type of data being clustered and the specific problem being solved.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system) and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

1. A computerized method for implementing the behavior of an entity mapper comprising:
creating an entity mapper comprising a plurality of entities, wherein each entity of the plurality of entities;
configuring each entity of the plurality of entities to be rearranged by a horizontal dragging operation and a scrolling operation; and
configuring each entity of the plurality of entities as a digital display image comprising an entity icon.

2. The computerized method of claim 1 further comprising:
configuring each entity of the plurality of entities to be deletable.

3. The computerized method of claim 2, wherein a deletion operation each entity of the plurality of entities deletes all subsequent information of the entity both in a section wise manner and an attribute-wise manner.

4. The computerized method of claim 1, wherein a maximum number of entities is configured to increase.

5. The computerized method of claim 4, wherein the entity marker icon comprises a digital symbol that serves as a visual identifier for selecting and associating each entity with an Attribute Scale Value.

6. The computerized method of claim 5, wherein the entity icon is represented by a digital image representing an entity provided by a user or system.

7. The computerized method of claim 6, wherein each entity corresponds to a persona, a product, a company, a service, that has a plurality of attributes relevant to a type of entity.

8. The computerized method of claim 7, wherein the plurality of attributes comprises a task, or a goal, or behavior, etc., that is associated to a specific scale value for each attribute.

9. The computerized method of claim 8 further comprising configuring each attribute and section with attributes to be rearranged by a vertical dragging operation.

10. The computerized method of claim 8, further comprising:
providing for a plurality of N entities namely E1, E2, . . . En, of the plurality of entities, wherein ‘n’ represents the position of the entity, and there exists M number of attributes labeled as A1, A2 . . . Am wherein ‘m’ represents the position of the attribute.

11. The computerized method of claim 10, further comprising:
Grouping each attribute under a Section which has V points on a discrete or a continuous scale labeled as S1, S2 . . . Sv, where ‘v’ represents the point on the scale.

12. The computerized method of claim 11, further comprising:
mapping each entity with one or more attributes at a scale value.

13. The computerized method of claim 12, the scale in a section remains constant for all the attributes in that section.

14. The computerized method of claim of 13, wherein each attribute at a position m, with a Scale Value at position v, associated with an entity n, is its Attribute Scale Value.

15. The computerized method of claim 14, further comprising:
associating each entity with an Attribute Scale Value via an Entity Marker Icon that represents the entity. And/or connecting each entity and its Marker Icon with an Attribute Scale Value via a visible line.

16. The computerized method of claim 14, further comprising:
the entity marker icons with the same attribute scale value on the scale have the same position and order as that of the entities.

17. The computerized method of claim of 14, further comprising:
Each attribute scale value is assigned a weight W based on which each entity and each attribute is scored in the mapper.

18. The computerized method of claim of 17, wherein each entity and each attribute score can be used for various ranking, similarity, difference, and gap with other entities and attributes

19. The computerized method of claim 16, wherein each entity is represented by a unique color and a unique entity icon.

20. The computerized method of claim 19, wherein the color of each entity is the same as that of the Marker Icon and the connecting line for each entity.
